(19) United States
(12) Patent Application Publication
(10) Pub. No.: US 2025/0378371 A1
(43) Pub. Date: Dec. 11, 2025

(54) AUTOMATIC TRANSACTION DATA ALLOCATION AND INTEGRATION

(71) Applicant: Ramp Business Corporation, New York, NY (US)

(72) Inventors: Samay Shamdasani, New York, NY (US); Isabella Turchetta, New York, NY (US); Rikin Patel, New York, NY (US)

(21) Appl. No.: 18/737,834

(22) Filed: Jun. 7, 2024

(51) Int. Cl. G06N 20/00

(52) U.S. Cl. CPC G06N 20/00

(57) ABSTRACT

A system for annotating transactions includes a computing server configured to receive transaction data of a transaction associated with a user account of a user. The user is associated with one or more transaction rules. The computing server generates a first embedding from the transaction data, the first embedding being in a latent space of a first machine-learned model. The computing server identifies a set of past transactions of the user. The server compiles a prompt that includes the transaction and the set of past transactions of the user and inputs the prompt to a machine-learned language model to request the machine-learned language model to allocate the transaction into one of the transaction rules. The server receives an output from the machine-learned language model and allocates the transaction data to the one of the transaction rules based on the output from the machine-learned language model.

### TECHNICAL FIELD

The present disclosure generally relates to using a machine-learned language model to allocate transaction data.

### BACKGROUND

Monitoring transactions is valuable for fraud prevention, resource allocation, budgeting, diagnostics, and more. To monitor transactions, data about the transactions are gathered and maintained using various software platforms that may be designed by different third parties. Various third-party software platforms have their own data schemas for organizing the transaction data. Those software platforms often use different schemas such as different metadata tags and data fields to annotate transactions.

### SUMMARY

Embodiments are related to spend allocation processes and architectures that reduce the processing and network bandwidth resource consumption by a computing server handling the spend allocations. In one embodiment, a computing server receives transaction data of a transaction associated with a user account of a user. The user is associated with one or more transaction rules. The user has one or more user accounts and the transaction rules impose one or more restrictions on the user that are applied across the user accounts. The computing server generates a first embedding from the transaction data, the first embedding being in a latent space of a first machine-learned model. The computing server identifies a set of past transactions of the user. To identify the set of past transactions of the user, the computing server generates second embeddings of past transactions of the user, compares the second embeddings of the past transactions to the first embedding in the latent space, and identifies the set of past transactions that are similar to the transaction based on the comparison of the second embedding to the first embedding. The computing server compiles a prompt that includes the transaction and the set of past transactions of the user. The computing server inputs the prompt to a machine-learned language model to request the machine-learned language model to allocate the transaction into one of the transaction rules. The computing server receives an output from the machine-learned language model. The computing server allocates the transaction data to one of the rules based on the output from the machine-learned language model.

### BRIEF DESCRIPTION OF THE DRAWINGS

Figure (FIG. 1 is a block diagram illustrating an example system environment, in accordance with an embodiment.

FIG. 2 is a block diagram illustrating components of an example computing server, in accordance with an embodiment.

FIG. 3 is a flowchart depicting an example process for automatic transaction matching, in accordance with an embodiment.

FIGS. 4A-B are flowcharts depicting an example process for automatic transaction matching, in accordance with an embodiment.

FIGS. 5A-B depict examples of user interfaces for processing transactions, in accordance with an embodiment.

FIG. 6 depicts an example user interface for processing a transaction, in accordance with an embodiment.

FIG. 7 is an example network model that may be used to generate an embedding, in accordance with an embodiment.

FIG. 8 is a block diagram illustrating components of an example computing machine, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

FIG. 1 is a block diagram that illustrates a transaction management system environment 100, in accordance with an embodiment. The system environment 100 includes a computing server 110, a data store 120, an end user transaction device 130, a third-party platform 140, a client device 150, and a transaction terminal 160. The entities and components in the system environment 100 communicate with each other through a network 190. In various embodiments, the system environment 100 includes fewer or additional components. In some embodiments, the system environment 100 also includes different components. While each of the components in the system environment 100 is described in a singular form, the system environment 100 may include one or more of each of the components. For example, in many situations, the computing server 110 can issue multiple end user transaction devices 130 for different end users. Different client devices 150 may also access the computing server 110 simultaneously.

The computing server 110 includes one or more computers that perform various tasks related to managing accounting, payments, and transactions of various clients of the computing server 110. For example, the computing server 110 creates credit cards and accounts for an organization client, manages transactions of the cards of the organization client based on rules set by the client (e.g., pre-authorization and restrictions on certain transactions), and facilitates the annotation by the end users involved in incurring the transactions (e.g., tagging the transactions with metadata tags specified third-party bookkeeping platform schemas). Examples of organizations may include commercial businesses, educational institutions, private or government agencies, or any suitable group of one or more individuals that engage in transactions with a named entity (e.g., a merchant) using an account associated with a credit card. In some embodiments, a named entity may be an identifiable real-world entity that may be detectable in the data of an organization. For example, a specific merchant may be a named entity and a merchant may refer to an organization that provides goods or services for purchase using the end user transaction device 130.

Client organizations may use third-party platforms (e.g., third-party platform 140) as bookkeeping tools to manage the transaction data resulting from the user accounts created for their personnel. The third-party platforms organize transaction data using their own data structures according to a schema. Each schema may include different data fields, which may include metadata tags and annotation data fields. The annotation and organization of transaction data into third-party schemas enables transaction data to be easily queried, sorted, and filtered due to the standardized structure provided by the schemas.

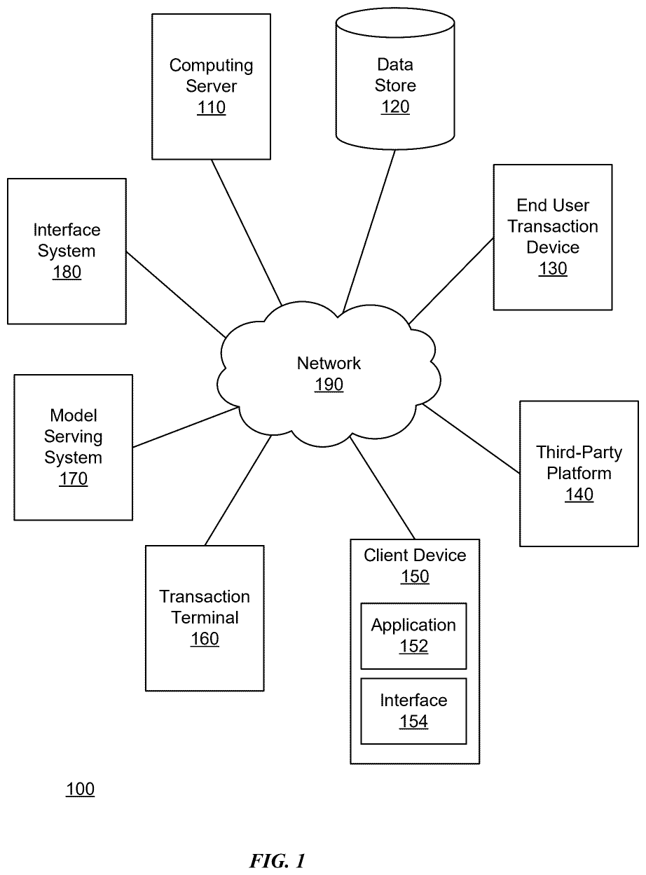

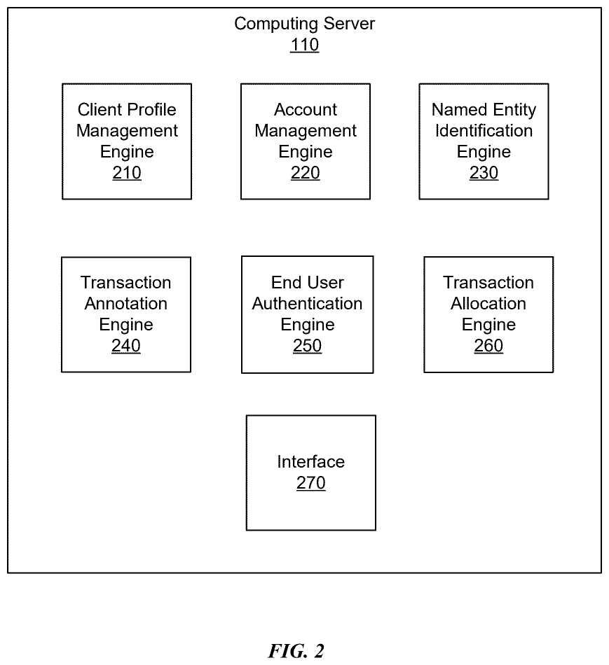

An end user may be a member of an organization client such as an employee of the organization or an individual that uses the end user transaction device 130 to make a purchase from a named entity. In one embodiment, the computing server 110 provides its clients with various payment and spending management services as a form of cloud-based software, such as software as a service (SaaS). Examples of components and functionalities of the computing server 110 are discussed in further detail below with reference to FIG. 2. The computing server 110 may provide a SaaS platform for various clients to manage their accounts and transaction rules related to the accounts.

The data store 120 includes one or more computing devices that include memory or other storage media for storing various files and data of the computing server 110. The data stored in the data store 120 includes accounting information, transaction data, credit card profiles, card rules and restrictions, merchant profiles, merchant identification rules, annotation rules for metadata tags with which transactions are to be annotated, or selection criteria for determining which transactions are to be annotated and other related data associated with various clients of the computing server 110. In various embodiments, the data store 120 may take different forms. In one embodiment, the data store 120 is part of the computing server 110. For example, the data store 120 is part of the local storage (e.g., hard drive, memory card, data server room) of the computing server 110. In some embodiments, the data store 120 is a network-based storage server (e.g., a cloud server). The data store 120 may be a third-party storage system such as AMAZON AWS, DROPBOX, RACKSPACE CLOUD FILES, AZURE BLOB STORAGE, GOOGLE CLOUD STORAGE, etc. The data in the data store 120 may be structured in different database formats such as a relational database using the structured query language (SQL) or other data structures such as a non-relational format, a key-value store, a graph structure, a linked list, an object storage, a resource description framework (RDF), etc. In one embodiment, the data store 120 uses various data structures mentioned above.

An end user transaction device 130 is a device that enables the holder of the device 130 to perform a transaction with a party (e.g., a named entity), such as making a payment to a merchant for goods and services based on information and credentials stored at the end user transaction device 130. An end user transaction device 130 may also be referred to as an end user payment device. Examples of end user transaction devices 130 include payment cards such as credit cards, debit cards, and prepaid cards, other smart cards with chips such as radio frequency identification (RFID) chips, portable electronic devices such as smart phones that enable payment methods such as APPLE PAY or GOOGLE PAY, and wearable electronic devices. The computing server 110 issues end user transaction devices 130 such as credit cards for its organization clients and may impose spending control rules and restrictions on those cards. While credit cards are often used as examples in the discussion of this disclosure, various architectures and processes described herein may also be applied to other types of end user transaction devices 130. In some cases, an end user transaction device 130 may also be a virtual device such as a virtual credit card.

A third-party platform 140 is a server that receives transaction data from multiple sources (e.g., various client organizations) and keeps data records of the transactions performed by the sources. A third-party platform may be referred to as a bookkeeping platform. Examples of bookkeeping platforms include NETSUITE, SAGE, and QUICKBOOKS. The third-party platform 140 may be operated by an entity different from the entity operating the computing server 110. Although one third-party platform is shown in FIG. 1, the computing server 110 may communicate with multiple third-party platforms. Each third-party platform may manage and maintain data records of transactions using respective schemas (e.g., data structure and fields can be unique to each third-party platform). For example, one third-party platform may store information describing a merchant category under the data field “class” while another third-party platform may store the information under the data field “group.” In another example, different third-party platforms may have a different number of data fields for recording transaction data. Additional examples of third-party platforms are described in U.S. patent application Ser. No. 17/498,664, entitled “Domain-Specific Data Records Synchronization,” filed Oct. 11, 2021, and is incorporated by reference herein for all purposes.

A client device 150 is a computing device that belongs to a client of the computing server 110. A client uses the client device 150 to communicate with the computing server 110 and performs various payment and spending management-related tasks such as creating credit cards and associated payment accounts, setting rules and restrictions on cards, setting pre-authorized or prohibited merchants or merchant categories (e.g., entertainment, travel, education, health, etc.), and managing transactions (e.g., requesting annotations for certain transactions using third-party platform schema data fields). The user of the client device 150 may be a manager, an accounting administrator, or a general employee of an organization. While in this disclosure a client is often described as an organization, a client may also be a natural person or a robotic agent. A client may be referred to an organization or its representative such as its employee. A client device 150 includes one or more applications 142 and interfaces 144 that may display visual elements of the applications 142. The client device 150 may be any computing device. Examples of such client devices 130 include personal computers (PC), desktop computers, laptop computers, tablets (e.g., iPads), smartphones, wearable electronic devices such as smartwatches, or any other suitable electronic devices.

The application 152 is a software application that operates at the client device 150. In one embodiment, the application 152 is published by the party that operates the computing server 110 to allow clients to communicate with the computing server 110. For example, the application 152 may be part of a SaaS platform of the computing server 110 that allows a client to create credit cards and accounts and perform various payment and spending management tasks (e.g., annotate transactions according to schemas of third-party platforms). In various embodiments, the application 152 may be of different types. In one embodiment, the application 152 is a web application that runs on JavaScript and other backend algorithms. In the case of a web application, the application 152 cooperates with a web browser to render a front-end interface 154. In another embodiment, the application 152 is a mobile application. For example, the mobile application may run on Swift for iOS and other APPLE operating systems or on Java or another suitable language for ANDROID systems. In yet another embodiment, the application 152 may be a software program that operates on a desktop computer that runs on an operating system such as LINUX, MICROSOFT WINDOWS, MAC OS, or CHROME OS.

An interface 154 is a suitable interface for a client to interact with the computing server 110. The client may communicate with the application 152 and the computing server 110 through the interface 154. The interface 154 may take different forms. In one embodiment, the interface 154 may be a web browser such as CHROME, FIREFOX, SAFARI, INTERNET EXPLORER, EDGE, etc. and the application 152 may be a web application that is run by the web browser. In one embodiment, the interface 154 is part of the application 152. For example, the interface 154 may be the front-end component of a mobile application or a desktop application. In one embodiment, the interface 154 also is a graphical user interface (GUI) which includes graphical elements and user-friendly control elements. In one embodiment, the interface 154 does not include graphical elements but communicates with the data management server 120 via other suitable ways such as application program interfaces (APIs), which may include conventional APIs and other related mechanisms such as webhooks.

In some embodiments, the client device 150 and the end user transaction device 130 belong to the same domain. For example, a company client can request the computing server 110 to issue multiple company credit cards for the employees. A domain refers to an environment in which a system operates and/or an environment for a group of units and individuals to use common domain knowledge to organize activities, information and entities related to the domain in a specific way. An example of a domain is an organization, such as a business, an institute, or a subpart thereof and the data within it. A domain can be associated with a specific domain knowledge ontology, which could include representations, naming, definitions of categories, properties, logics, and relationships among various concepts, data, transactions, and entities that are related to the domain. The boundary of a domain may not completely overlap with the boundary of an organization. For example, a domain may be a subsidiary of a company. Various divisions or departments of the organization may have their own definitions, internal procedures, tasks, and entities. In other situations, multiple organizations may share the same domain.

A transaction terminal 160 is an interface that allows an end user transaction device 130 to make electronic fund transfers with a third party such as a third-party named entity. Electronic fund transfer can be credit card payments, automated teller machine (ATM) transfers, direct deposits, debits, online transfers, peer-to-peer transactions such as VENMO, instant-messaging fund transfers such as FACEBOOK PAY and WECHAT PAY, wire transfers, electronic bill payments, automated clearing house (ACH) transfer, cryptocurrency transfer, blockchain transfer, etc. Depending on the type of electronic fund transfer, a transaction terminal 160 may take different forms. For example, if an electronic fund transfer is a credit card payment, the transaction terminal 160 can be a physical device such as a point of sale (POS) terminal (e.g., a card terminal) or can be a website for online orders. An ATM, a bank website, a peer-to-peer mobile application, and an instant messaging application can also be examples of a transaction terminal 160. The third party is a transferor or transferee of the fund transfer. For example, in a card transaction, the third party may be a named entity (e.g., a merchant). In an electronic fund transfer such as a card payment for a merchant, the transaction terminal 160 may generate a transaction data payload that carries information related to the end user transaction device 130, the merchant, and the transaction. The transaction data payload is transmitted to other parties, such as credit card companies or banks, for approval or denial of the transaction.

Various servers in this disclosure may take different forms. In one embodiment, a server is a computer that executes code instructions to perform various processes described in this disclosure. In another embodiment, a server is a pool of computing devices that may be located at the same geographical location (e.g., a server room) or be distributed geographically (e.g., cloud computing, distributed computing, or in a virtual server network). In one embodiment, a server includes one or more virtualization instances such as a container, a virtual machine, a virtual private server, a virtual kernel, or another suitable virtualization instance.

In some embodiments, language models used by the computing server 110 to analyze data are large language models (LLMs) that are trained on a large corpus of training data to generate outputs for the natural language processing (NLP) tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has a significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the computing server 110 or entities/systems different from the computing server 110. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

The model serving system 170 receives requests from the computing server 110 to perform inference tasks using machine-learned language models. The inference tasks include, but are not limited to, NLP tasks, audio processing tasks, image processing tasks, video processing tasks, and the like. In some embodiments, the machine-learned language models deployed by the model serving system 170 are models configured to perform one or more NLP tasks. The NLP tasks include, but are not limited to, text generation, query processing, machine translation, chatbot applications, and the like. In some embodiments, the language model is configured as a transformer neural network architecture. Specifically, the transformer model is coupled to receive sequential data tokenized into a sequence of input tokens and generates a sequence of output tokens depending on the inference task to be performed.

The model serving system 170 receives a request including input data (e.g., text data, audio data, image data, transaction data, or video data) and encodes the input data into a set of input tokens. The model serving system 170 applies the machine-learned language model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represent a translation of the paragraph or sentence in English. For a text generation task, the transformer model may receive a prompt and continue the conversation or expand on the given prompt in human-like text.

When the machine-learned language model is a language model, the sequence of input tokens or output tokens is arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like.

In some embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While an LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In some embodiments, the inference task for the model serving system 170 can primarily be based on reasoning and summarization of knowledge specific to the computing server 110, rather than relying on general knowledge encoded in the weights of the machine-learned language model of the model serving system 170. The domain-specific knowledge and information may be provided by an interface system 180. One type of inference task may be to perform various types of queries on large amounts of data in an external corpus in conjunction with the machine-learned language model of the model serving system 170. For example, the inference task may be to perform question-answering, text summarization, text generation, and the like based on information contained in the external corpus.

The interface system 180 provides the search to the model serving system 170. By contrast, entering domain-specific knowledge data manually can be time-consuming. A system that creates a context for the intent and fills it in with data from all known systems can produce a very rich query or combination of queries to stitch together for rich information returns. The interface system 180 is used to manage complex queries for the model serving system 170 to provide rich information returns. The interface system 180 additionally manages the processing of query results from the systems contained in the model serving system 170.

In various embodiments, the functionalities and components described herein may be distributed among computing server 110, model serving system 170, and interface system 180. For example, in some embodiments, any NLP tasks may be performed by the model serving system 170, including analyzing the intention, and providing a response. In some embodiments, the computing server 110 may perform the intent inference and provide the inferred intent to the model serving system 170 to generate responses. In some embodiments, the computing server 110 may provide transaction data to the interface system 180 as training data and response data on which the model serving system 170 is based. In some embodiments, the model serving system 170 may be operated by a different entity than the computing server 110. In some embodiments, the computing server 110 may fine tune a machine-learned language model provided by the model serving system 170. In some embodiments, the computing server 110 may train and store its own machine-learned language model.

The network 190 provides connections to the components of the system environment 100 through one or more sub-networks, which may include any combination of local area and/or wide area networks, using both wired and/or wireless communication systems. In one embodiment, a network 190 uses standard communications technologies and/or protocols. For example, a network 190 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 190 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 190 may be represented using any suitable format, such as hypertext markup language (HTML), extensible markup language (XML), JavaScript object notation (JSON), and structured query language (SQL). In some embodiments, some of the communication links of a network 190 may be encrypted using any suitable technique or techniques such as secure sockets layer (SSL), transport layer security (TLS), virtual private networks (VPNs), Internet Protocol security (IPsec), etc. The network 190 also includes links and packet switching networks such as the Internet. In some embodiments, a data store belongs to part of the internal computing system of a server (e.g., the data store 120 may be part of the computing server 110). In such cases, the network 190 may be a local network that enables the server to communicate with the rest of the components.

### Example Server Components

FIG. 2 is a block diagram illustrating components of a computing server 110, in accordance with an embodiment. The computing server 110 includes a client profile management engine 210, an account management engine 220, a named entity identification engine 230, a transaction annotation engine 240, an end user authentication engine 250, a spend allocation engine 260, and an interface 270. In various embodiments, the computing server 110 may include fewer or additional components. For example, in some embodiments, the computing server 110 may also include a transaction approval server. The functions of various components may be distributed in a different manner than described below. Moreover, while each of the components in FIG. 2 may be described in a singular form, the components may present in plurality. The components may take the form of a combination of software and hardware, such as software (e.g., program code comprised of instructions) that is stored on memory and executable by a processing system (e.g., one or more processors).

The client profile management engine 210 stores and manages end user data and transaction data of clients of the computing server 110. The computing server 110 can serve various clients associated with end users such as employees, vendors, and customers. For example, the client profile management engine 210 may store the employee hierarchy of a client to determine the administrative privilege of an employee in creating a credit card account and in setting transaction rules, selection criteria for annotating transactions, and annotation requirements. An administrator of the client may specify that certain employees from the financial department and managers have the administrative privilege to create cards for other employees.

The client profile management engine 210 may organize or categorize transaction data of an organization client according to metadata tags (e.g., the annotation requirements specified by the organization client). The metadata tags can include tags specified by a third-party platform, create tags (e.g., tags for transaction types, merchants, date, amount, card, employee groups, etc.), or a combination thereof. The client profile management engine 210 may process transactions on behalf of an organization client by generating and organizing the transaction data of the transactions into a data structure. Each entry of the data structure may correspond to a transaction. The fields of the data entries can include the metadata tags. The client profile management engine 210 can annotate a data entry by storing values in the fields of the data entries. For example, the client profile management engine 210 annotates a data entry with values of data fields of a third-party platform's schema by storing the values in fields of the data entry assigned to the schema's data fields. The client profile management engine 210 may use a common or standardized data structure format for organizing the transaction data of a client. This standardized format may enable different third-party platforms' schema to be standardized within a single data structure. For example, a single client may use two different bookkeeping platforms. Each of the bookkeeping platforms can use the same data field name or different data field names across their different schemas (e.g., one platform uses “category” and another uses “group”). The client profile management engine 210 may maintain a mapping of different data field names that refer to the same characteristic of transaction data, and use the mapping when creating or updating a data entry with transaction data or user-provided annotations. In this way, the computer server 110 can receive annotation for various schemas and organize the annotation into a common format for organizing transaction data agnostic of the third-party platform used for annotating the transaction data.

The client profile management engine 210 can monitor the spending of a client by category and also by the total spending. The spending amounts may affect the results of transaction rules and selection criteria for annotating transactions that are specified by an organization client's administrator. For example, a client may limit the total monthly spending of an employee group. The computing server 110 may deny further card payments after the total spending exceeds the monthly budget.

The account management engine 220 creates and manages accounts including payment accounts such as credit cards that are issued by the computing server 110. An account is associated with an end user such as an employee and corresponds to a card or an end user transaction device. A client may use the computing server 110 to issue domain-specific payment accounts such as company cards. The client enters account information such as the cardholder's name, role and job title of the cardholder in the client's organization, limits of the card, and transaction rules associated with the card. The client may use the client device 150 and the interface 154 to supply this information to the computing server 110. In response to receiving the account information (e.g., from the client device 150), the account management engine 220 creates the card serial number, credentials, a unique card identifier, and other information needed for the generation of a payment account and corresponding card. The account management engine 220 associates the information with the cardholder's identifier. The computing server 110 communicates with a credit card company (e.g., VISA, MASTERCARD) to associate the card account created with the identifier of the computing server 110 so that transactions related to the card will be stored at client profile management engine 210 with a mapping to identifiers for the account and the client's organization for querying transactions of the client organization. The account management engine 220 may also order the production of the physical card that is issued under the computing server 110. The cards and payment accounts created are associated with the transaction rules, selection criteria for annotating transactions, and/or annotation requirements that are specified by the client's administrator.

In some embodiments, the account management engine 220 creates and stores selection criteria that specify annotations are required for transaction data that meet the selection criteria. A client may provide to the computing server 110 criteria under which transactions are to be annotated by the computing server 110. The client may use the interface 154 of the client device 150 to specify the criteria. Examples of selection criteria can include a transaction amount, a transaction location, a transaction date, a third-party named entity category, a third-party named entity name, any suitable parameter related to a transaction, or a combination thereof. In one example of a rule, the client specifies that an annotation is required for transaction amounts above seventy-five dollars. In another example of a rule, the client specifies that annotations are not required for transactions incurred with a particular merchant. In some embodiments, the account management engine 220 may recommend selection criteria to a client based on a history of selection criteria used by clients that share similar characteristics (e.g., industry type, number of employees, card transaction rules, etc.). The client may specify priority for criteria such that a certain criterion may override another criterion. For example, the account management engine 220 may determine that, under the previous two examples of criteria, the client has specified that rules for requiring annotations override rules for not requiring annotation, and cause the transaction annotation engine 240 to request an annotation for, for example, a transaction made with the particular merchant that was over seventy-five dollars.

Upon determining whether the annotation is needed using the selection criteria created by the account management engine 220, the transaction analysis engine 240 may annotate or flag a record of the transaction with an indicator that the transaction is unannotated and whether it needs to be annotated. This indicator may be used when generating a user interface for the client when managing annotation statuses of past transactions. The selection criteria may be different for each cardholder, each cardholder program (e.g., multiple cardholders sharing one or more characteristics specified by a client can be grouped into a program), or each client. In this way, for example, a client can customize which transactions are to be annotated rather than apply a single rule for employees in different groups who may use the cards in different ways. A client may establish such rules through an interface generated by the interface 250.

The account management engine 220 creates and stores annotation requirements regarding which data fields (e.g., metadata tags) are required for annotating the transaction data that meets the selection criteria. The data fields can include data fields of a third-party platform. Different third-party platforms may have different schemas (e.g., different permutations of data fields) for organizing transaction data. The account management engine 220 may receive data fields from third-party platforms and receive annotation requirements from clients specifying which third-party platform and schema to use for the user accounts of the client. A single client may use one or more third-party platforms, and the account management engine 220 may maintain a record of which third-party platforms are used for which of the user accounts of the client. The account management engine 220 can receive one or more selection criteria from an organization client (e.g., via the interface 154).

The named entity identification engine 230 identifies specific named entities (e.g., merchants) associated with various transactions. The computing server 110 may impose an entity-specific restriction on a card. For example, an administrator of a client may specify that a specific card can only be used with a specific named entity. The computing server 110 parses transaction data from different clients to identify patterns in the transaction data specific to certain named entities to determine whether a transaction belongs to a particular named entity. For example, in a card purchase, the transaction data includes merchant identifiers (MID), merchant category code (MCC), and the merchant name. However, those items are often insufficient to identify the actual merchant of a transaction. The MID is often an identifier that does not uniquely correspond to a merchant. In some cases, the MID is used by the POS payment terminal company such that multiple real-world merchants share the same MID. In other cases, a merchant (e.g., a retail chain) is associated with many MIDs with each branch or even each registry inside a branch having its own MID. The merchant name also suffers the same defeats as the MID. The merchant name may also include different abbreviations of the actual merchant name and sometimes misspellings. The string of the merchant name may include random numbers and random strings that are not related to the actual real-world name of the merchant. The named entity identification engine 230 applies various algorithms and machine learning models to determine the actual merchant from the transaction data. For example, the named entity identification engine 230 may search for patterns in transaction data associated with a particular merchant to determine whether a transaction belongs to the merchant. For example, a merchant may routinely insert a code in the merchant name or a store number in the merchant name. The named entity identification engine 230 identifies those patterns to parse the actual merchant name.

A named entity identification process may be used to determine the identities of named entities included in processed real-time transactions. In one embodiment, the computing server 110 determines a named entity identification rule by analyzing patterns in the volume of data associated with the plurality of clients. For example, the volume of data may include past transaction data payloads of different clients. The computing server 110 may analyze the past transaction data payloads to determine a common pattern associated with the payloads of a particular named entity. The named entity identification rule may specify, for example, the location of a string, the prefix or suffix to be removed, and other characteristics of the data payload. The computing server 110, upon the receipt of a transaction data payload, identifies a noisy data field in the transaction data (e.g., a noisy string of text). A noisy data field is a field that includes information more than the named entity. For example, a noisy data field may include a representation of a named entity, such as the name, an abbreviation, a nickname, a subsidiary name, or an affiliation of the named entity. The noisy data field may further include one or more irrelevant strings that may be legible but irrelevant or may even appear to be gibberish. The computing server 110 parses the representation of the named entity based on the named entity identification rule. A transaction approval process can be based on the identity of the named entity. This general framework may be used by one or more computing servers to identify named entities in transaction data payloads.

The transaction annotation engine 240 annotates transactions incurred between third-party named entities and user accounts of clients. The transaction annotation engine 240 may identify transactions that need to be annotated based on selection criteria stored in the account management engine 220. The transaction annotation engine 240 can identify an end user who is responsible for annotating the identified unannotated transaction. The transaction annotation engine 240 may send requests to responsible end users to annotate the transactions. After receiving an annotation from a responsible end user, the transaction annotation engine 240 may create annotated transaction data entries. In one example of creating an annotated transaction data entry, the transaction annotation engine 240 may store values provided by the user for annotation into a data entry for the corresponding unannotated transaction. The data entry may include fields for annotation (e.g., data fields of a third-party platform's schema for annotating transactions). By identifying unannotated transactions that need to be annotated, identifying end users to annotate the transactions, and requesting the end users to annotate the transactions, the transaction annotation engine 240 enables the computing server 110 to maintain a database of transaction data that is up to date with metadata tags for organizing transactions for clients. In particular, different clients may use different sets of metadata tags for annotation. For example, different clients may use different bookkeeping platforms to organize transactions made by employees. The transaction annotation engine 240, by using the annotation requirements that specify which annotation tags the different clients, cardholders, or programs of cardholders can use, enables the computing server 110 to conserve processing resources at the computing server 110 by distributing the annotation task to end users. For example, rather than the computing server 110 determining annotation information in varying schemas for tens of thousands of transactions by end users daily, the computing server 110 generates user interfaces that guide the end users to properly annotate transaction information according to an appropriate schema for their client organization or account. In this way, the computing server 110 can reduce processing resources generating a user interface at a much smaller scale (e.g., ten of the same interfaces) than processing tens of thousands of different transactions daily.

The transaction annotation engine 240 can access one or more selection criteria stored in the account management engine 220. A selection criterion may specify transactions that need to be annotated. The transaction annotation engine 240 may traverse transactions (e.g., traversing entries in a data structure of transaction data) and determine one or more of the transactions that need to be annotated according to the selection criteria. For example, the selection criteria specify that transactions for a particular group of cardholders (e.g., a cardholder program) need to be annotated if they are made with merchants that provide subscription services (e.g., reoccurring transactions made using the same user account). The computing server 110 may identify reoccurring transactions, example methods for which are discussed in further detail in the U.S. patent application Ser. No. 17/390,701, entitled “User Interface for Recurring Transaction Management,” filed Jul. 30, 2021, and is incorporated by reference herein for all purposes. The transaction engine 240 may then flag the transactions that meet the selection criteria as unannotated transactions that need annotations.

The transaction annotation engine 240 can request end users of the accounts used to incur the unannotated transactions to annotate the unannotated transactions. To request that end users annotate the unannotated transactions, the transaction annotation engine 240 can identify end users responsible for annotating the transactions and transmit a direct link to those responsible end users. To identify a responsible end user, the transaction annotation engine 240 can query for a user identifier to contact the responsible user using the account (e.g., an account number associated with the account). In one example, the client profile management engine 210 can be queried by the transaction annotation engine 240 using an account number to determine a profile that maps a user identifier (e.g., email address, phone number, or SaaS platform user name) to the account number. The transaction annotation engine 240 can generate a direct link that can bring the responsible end user to an annotation page to annotate one or more transactions.

The transaction annotation engine 240 can transmit a direct link to responsible end users through one or more communication channels. Examples of communication channels include an email service, a short message service (SMS), or a website hosted by the computing server 110. The transaction annotation engine 240 may transmit a request to a third-party application service (e.g., FIREBASE) to generate a direct link and receive the direct link from the third-party application service. In some embodiments, the direct link may cause a web browser to directly land on a webpage that is used for the annotation without further selection by the responsible end user on the transactions. In some embodiments, the direct link may land the user on an annotation webpage without further verification or authentication. For example, the user may not need to provide login credentials before accessing the annotation webpage through the direct link. The annotation webpage may be specific to the particular responsible end user and may automatically match the particular transaction that needs to be annotated. The webpage includes user input fields for the responsible user to provide annotation data field values. This webpage may be referred to as an annotation webpage. The annotation webpage can be specific to a particular transaction so that the user input fields for annotation may be used by the transaction annotation engine 240 to fill a data entry that corresponds to a specific transaction. The user input fields of the annotation webpage may be generated according to annotation requirements for the responsible end user or the transaction.

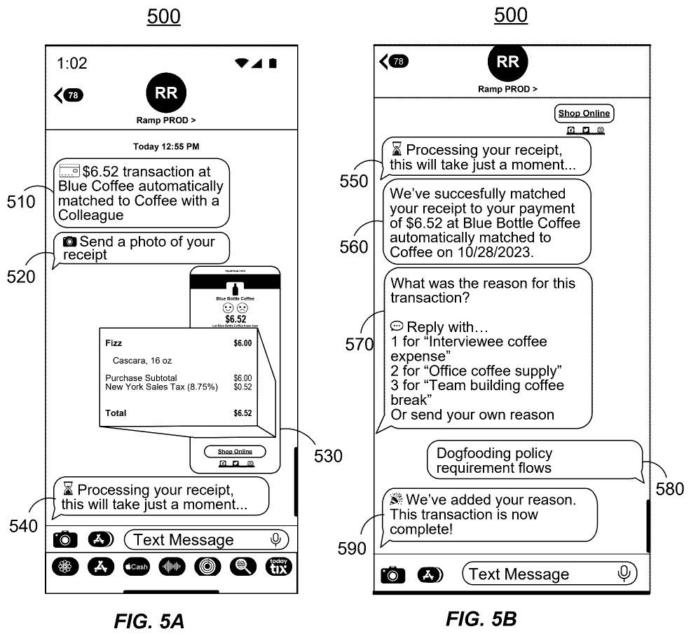

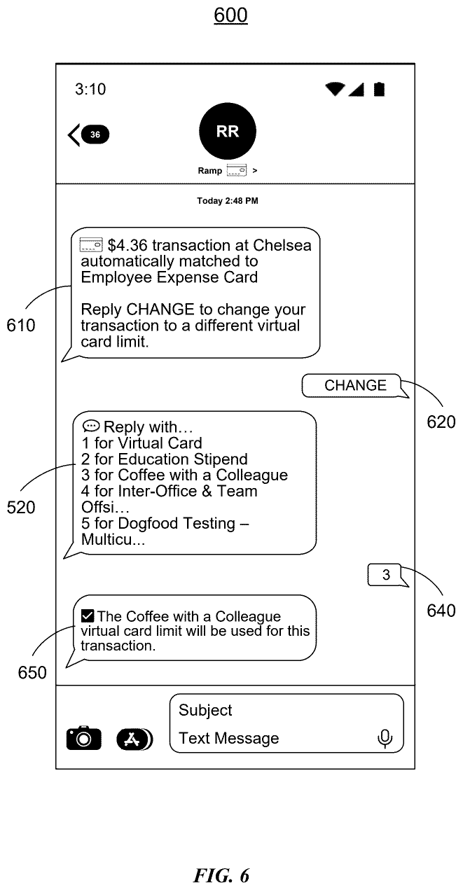

In some embodiments, the transaction annotation engine 240 may request that a responsible end user annotate a transaction without a direct link. An example of using SMS to request a user annotate a transaction is shown in FIGS. 5A-5B and 6. The transaction annotation engine 240 directly prompts the user to supply annotation data field values using questions. A question may be associated with a particular data field that is required to be annotated according to a client's annotation requirements. Before or while providing the request for an end user to annotate an unannotated transaction, the transaction annotation engine 240 may instruct the end user authentication engine to verify the identity of the end user. The transaction annotation engine 240 may verify the identity before receiving an annotation from the user and creating an annotated data entry.

The transaction annotation engine 240 may receive, from the end users, annotations of the unannotated transactions. In some embodiments, one or more annotations include data field values of a third-party platform's schema. An end user may provide annotations using a device and a communication channel (e.g., email, SMS, or SaaS platform website). The computing server 110 may provide a user interface for the end user to provide the annotations. In some embodiments, the transaction annotation engine 240 may receive different annotations for end users of different organization clients. Those organization clients may use different third-party platforms. Accordingly, the received annotations may have different data field values corresponding to schemas used by the different third-party platforms.

The end user authentication engine 250 may verify the identity of an end user that is annotating a transaction. The end user authentication engine 250 may execute a multi-factor authentication (MFA) process with an end user. In response to the end user successfully completing the MFA process, the end user authentication engine 250 may generate a token that includes authentication information and store the token on a device of the end user. The end user authentication engine 250 may encrypt the token and store the encrypted token on the device. In one example of creating and storing an encrypted token, the end user authentication engine 250 creates an encrypted Hypertext Transfer Protocol (HTTP) cookie using Advanced Encryption Standard (AES) 256 and stores the encrypted HTTP cookie at a web browser application of the end user's device. Other token and encryption methods may be used to create and store tokens carrying authentication information (e.g., JSON Web Token (JWT)). The authentication information stored in a token may include a date/time on which the token is created, an identifier of the end user's device (e.g., device class such as tablet or smartphone), or an identifier of the end user (e.g., the end user's name). Each token may have an expiration date that can be calculated using the date/time on which the token was created. By storing an encrypted token on the user's device, the computing server 110 may use the encrypted token to authenticate the user without requiring the user to provide login credentials to annotate transactions.

In one example of authenticating an end user, the end user authentication engine 250 accesses the encrypted token stored in the end user's device in response to the end user selecting a direct link. The end user authentication engine 250 then decrypts the encrypted token to obtain authentication information of the end user and determines that the token has not expired based on a creation date included in the authentication information. In response to determining the token has not expired, the end user authentication engine 250 verifies the identity of the end user using the direct link and the authentication information. In some embodiments, if the identity of the user cannot be verified using the encrypted token, the end user authentication engine 250 may prompt the user to provide login credentials (e.g., perform an MFA process).

The spend allocation engine 260 automatically allocates transactions to a category that may be governed by one or more transaction rules. For example, a user employee may be subject to one or more transaction rules that may be applied to any accounts associated with the user. The transaction rules may set criteria based on data related to the user, the transaction nature, the counterparties, and other suitable conditions. For example, the rules may take any suitable forms to impose restrictions based on one or more criteria such as budgets on transactions (e.g., budget per transaction or budget in aggregation), conditions on the transactions based on the nature of transactions (e.g., a limit on dining, no limit on spending on transportation, etc.), limits on third-party named entities to be transacted (e.g., certain merchants may be allowed or restricted), limits on date, locations, time periods, and other contextual conditions, rules based on the roles or groups in the organizations, and other suitable transaction rules. Each user may be associated with one or more transaction rules that impose restrictions applied across their accounts. For example, the organization (e.g., the employer) may set a budget on a certain spending category (e.g., a rule restricting the lunch spending limit) that is applied to the user for a particular period (e.g., every month) regardless of which account the user uses to conduct the transactions. Put differently, the user may incur a transaction under the rule using a direct account issued by the organization (e.g., a company card), using cash then seeking reimbursement, and other ways to conduct various transactions. The spend allocation engine 260 automatically identifies those transactions that should be governed by the rule and allocates those transactions to the rule.

Conventionally the user may need to manually assign a transaction that occurred to a particular category under which a rule governs. In some embodiments, the spend allocation engine 260 applies one or more machine learning model techniques to automatically allocate the transactions. By way of example, the spend allocation engine 260 may obtain transaction data associated with a user's account. The spend allocation engine 260 may use the gathered transaction data (which may be referred to as the target transaction data of the target transaction) to create a first embedding. This embedding may be generated via a machine-learned model and is extracted from a latent space, which may correspond to a hidden layer in the machine-learned model. The spend allocation engine 260 may use the first embedding that represents the target transaction to identify similar past transactions using one or more suitable machine learning techniques. For example, the spend allocation engine 260 may identify a set of the user's past transactions and generate second embeddings for these past transactions. The spend allocation engine 260 may compare these second embeddings to the first embedding in the latent space and identify past transactions that are similar to the present transaction. The selected subset of the past transactions may be used as a reference for a language model (e.g., a large language model, a transformer model) to automatically assign the target transaction to a rule. For example, the past transactions may each be assigned to a rule. The spend allocation engine 260 may construct a prompt that incorporates the current transaction and the set of identified past transactions. The constructed prompt may be input to a machine-learned language model to ask the language model to assign the target transaction to a rule. The spend allocation engine 260 may receive an output from the machine-learned language model. This model, based on its training, may provide an allocation for the transaction based on the provided prompt. The spend allocation engine 260 may allocate the transaction data to the rule determined by the output from the machine-learned language model. In some embodiments, the first machine-learned model that is used to generate embeddings is the same as the machine-learned language model used for providing allocation. In some embodiments, the two models are different models.

In some embodiments, the spend allocation engine 260 may compare the output received from the machine-learned language model to a dataset of spend allocations specific to that user. This dataset could include information on how the user has historically allocated their transactions across different categories or budgets. The spend allocation engine 260 may then determine if the output from the machine-learned model matches any spend allocation data within the dataset. This may include identifying if the allocation suggested by the model corresponds to an existing category in the user's spending history. If a match is found, the spend allocation engine 260 may allocate the transaction data to the spend allocation associated with the matched spend allocation data. The transaction may be categorized or assigned to an expenditure type that aligns with the matched spend allocation data. This embodiment of the spend allocation engine 260 places a new transaction into an existing category by comparing the suggested allocation from the machine-learned model output against the user's past transaction patterns and allocations.

In some embodiments, the spend allocation engine 260 may add a layer of certainty assessment to the process. For example, the spend allocation engine 260 may first identify a confidence score from the output of the machine-learned model. This confidence score may indicate the degree of certainty that the model has in its allocation decision. The spend allocation engine 260 may then compare this confidence score to a predefined threshold. This threshold is a set value that the confidence score needs to exceed to be considered valid. If the confidence score of the output from the machine-learned model exceeds this predetermined threshold, the spend allocation engine 260 may proceed to allocate the transaction data to the spend allocation associated with the matched spend allocation data. This embodiment of the spend allocation engine 260 provides an allocation logic, such as a failsafe. Advantageously, this allocation logic ensures that the automated allocation only occurs when the spend allocation engine 260 is confident in the accuracy of its decision. This increases the reliability of automated spend allocation.

In some embodiments, the spend allocation engine 260 may include a more complex process that enables the computing server 110 to handle scenarios where the output from the machine-learned language model does not exactly match any spend allocation data within the user's dataset of spend allocations. The spend allocation engine 260 may compare the output from the machine-learned language model to a dataset of the user's spend allocations. The spend allocation engine 260 may check if the output from the machine-learned model matches one of the spend allocation data within the user's dataset. If an exact match is found, the transaction data may be allocated accordingly. If an exact match is not found, the spend allocation engine 260 may identify a subset of the dataset that is close or similar to the output from the machine-learned language model. It does this by creating an embedding of the output from the model and an embedding for each spend allocation data in the latent space of a machine-learned model. The latent space representations help assess similarities and proximity. The spend allocation engine 260 may compare the embeddings of the output to each spend allocation data. Then, the spend allocation engine 260 may determine a subset that is closest to, or most similar to the output. The spend allocation engine 260 may allocate the transaction data to one of the spend allocations that is part of this identified subset. This process may allow the spend allocation engine 260 to allocate transactions even when the output from the machine-learned model does not directly correspond to an existing allocation. Through leveraging embeddings and latent space comparisons, the spend allocation engine 260 may locate the most similar or closest match and utilize that for allocation.

In some embodiments, the spend allocation engine 260 may incorporate a user-interactive element to assist with the allocation of transaction data. After an initial allocation suggestion has been made by the machine-learned language model, the spend allocation engine 260 may send a request to the user associated with the transaction for annotation. The spend allocation engine 260 may determine the user's identity and send a message to the user requesting annotations via a communication channel. This channel may be an SMS, an email, or a SaaS platform. The request may include the machine-predicted allocation and ask the user to simply confirm the allocation. Alternatively, or additionally, the request may include a list of a few candidate allocations for the user to make a choice of the right allocation. The user may provide their annotation for the transaction through the same communication channel. The annotation may be a confirmation or modification of the suggested allocation, thereby offering a manual check or correction step to ensure the accuracy of the allocation. The spend allocation engine 260 may allocate the transaction data to a particular spend allocation based on the received annotations from the user. This means the ultimate allocation decision may incorporate both the machine-learned model's recommendations and direct user annotation input. Advantageously, this embodiment may leverage both automated artificial intelligence processing and human annotation, improving the accuracy and flexibility of the spend allocation method.

The interface 270 includes interfaces that are used to communicate with different parties and servers. The interface 270 may take the form of a SaaS platform that provides clients with access to various functionalities provided by the computing server 110. The interface 270 provides a portal in the form of a GUI for clients to create payment accounts, manage transactions, specify the rules of each card, and annotate transactions incurred using the cards. The interface 270 is in communication with the application 152 and provides data to render the application 152. The interface 270 may be in communication with a third-party platform (e.g., the third-party platform 140) to export transaction data to the third-party platform. For example, the computing server 110 may use the interface 270 to provide transaction data to the third-party platform 140 in batches by providing the data structure of transactions for a client in a file format suitable for the data structure (e.g., a spreadsheet file). The interface 270 may provide a portal for display that shows annotated transaction data that includes annotation provided by end users (e.g., data field values of third-party platforms' schemas). The portal may include a GUI element that allows a user to export the annotated transaction data to a third-party platform. The interface 270 may generate a portal of annotated transaction data that can be sorted according to schemas used to annotate the transactions.

In some embodiments, the interface 270 may generate annotation webpages for an end user to provide annotation for an unannotated transaction. The interface 270 may generate different annotation webpages for different end users. For example, different users may be subjected to different annotation requirements and thus, the annotation webpages can include different input elements for the different annotation requirements. The annotation requirements may be different due to a client specifying different data fields of the same schema required for different accounts. The annotation requirements may be different due to differences in schemas of third-party platforms. The interface 270 may use a communication channel such as SMS, email, or SaaS platform website to communicate with end users or administrators of clients.

In one embodiment, the interface 270 also includes an API for clients of the computing server 110 to communicate with the computing server 110 through machines. The API allows the clients to retrieve the computing server 110 stored in the data store 120, send query requests, and make settings through a programming language. Various settings, creation of cards, rules on the cards, rules of annotating transactions, and other functionalities of the various engines 210, 220, 230, 240, 250 and 270 may be changed by the clients through sending commands to the API.

### Example Process for Automatic Transaction Matching

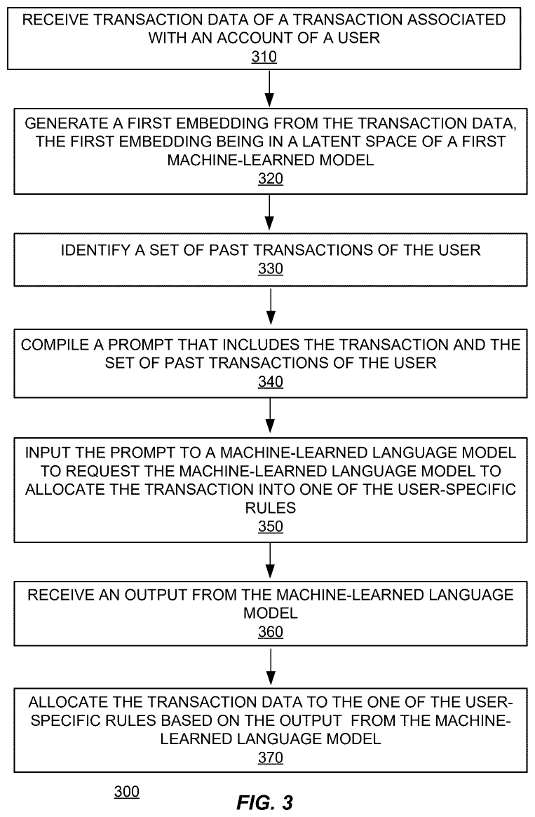

FIG. 3 is a flowchart depicting an example process 300 for automatic transaction matching, in accordance with some embodiments. The process may be performed by the spend allocation engine 260 or any other engine of the computing server 110 illustrated in FIG. 2. The process 300 may be embodied as a software algorithm that may be stored as computer instructions that are executable by one or more processors. The instructions, when executed by the processors, cause the processors to perform various steps in the process 300. In various embodiments, the process may include additional, fewer, or different steps. While various steps in process 300 may be discussed with the use of computing server 110, each step may be performed by a different computing device.

In some embodiments, the computing server 110 may receive 310 transaction data of a transaction associated with a user account of a user. The user may be associated with one or more transaction rules, such as user-level transaction rules. The user may have one or more user accounts. The transaction rules may impose one or more restrictions on the user across the one or more user accounts.

The user may be an individual who is part of an organization and who is granted access to a certain amount of funds, or budgets, for specific categories of expenditure, such as wellness benefits, lunches, or travel expenses. These budgets may be made available to the user through user accounts affiliated with the organization. While a budget rule is used as an example of the transaction rule, other transaction rules may also be allocated using the process 300.

A transaction may include any instance of transactions performed by a user, including utilizing their credit card (e.g., physical card, virtual card, etc.) linked to their user account on a transaction terminal (e.g., the transaction terminal 160 of FIG. 1), paying cash and seeking reimbursement, paying using the user's personal card and seeking reimbursement, incurring automatically payment, paying using a bank account or electronic check, etc. Each transaction may include specific data such as transaction amount, the date and time of the transaction, the location of the transaction, and the merchant, among other details. For example, the transaction data may be received at the computer server 110 and stored in the data store 120 of FIG. 1. The amount of detail and data vary, depending on the type of transactions and the entities involved, making the issue of allocating a transaction to a rule challenging with a conventional algorithm.

A user account may be any suitable account that is associated with the user. The user account may be linked to a physical credit card or a virtual card used for transactions by the user. The user account may be bound by specific rules and regulations as determined by an administrator such as a manager of the finance team within the user's organization. The accounts of the user may be subject to specific restrictions or rules. These rules may be aligned with a specific individual(s) or their role within the organization. The rules may dictate how much a user may spend within each category of expenditure.

In some embodiments, one of the examples of a transaction rule may be an individualized regulation or guideline that is applied to the user, regardless of how the user incurred the transaction or which account was used to carry out the transaction. These rules may serve to stipulate the manner in which the user may spend funds associated with their account. Transaction rules may be set by an administrator or a finance team, minimizing the risk of unauthorized or inappropriate expenditure. Examples of transactions may include wellness stipend, lunch, work-from-home (WFH) expenses, and inter-office travel rules. For a wellness stipend, a certain amount of money may be allocated to the user each month for wellness activities, like gym memberships, meditation classes, or therapist sessions. The lunch rule may allocate a small budget per week or month for the user to spend on casual, work-related lunch meetups. If a user is working remotely, a rule may assign a specific budget for the user to spend on home office equipment, internet bills, or other associated costs. An inter-office travel rule may establish a specific budget to cover transportation costs.

In some embodiments, a user transaction platform (e.g., computer server 110) may receive a record of transactions, allowing the adjustment of the rules or categories and facilitating the administration of funds as dictated by the established rules. In some embodiments, the user transaction platform may provide a tool for managing a user's spending within the designated areas outlined by the organization, maintaining a balance between user convenience and organizational control over spending.

In some embodiments, receiving the transaction data of the transaction associated with the user account of the user may include detecting a transaction associated with the user account of the user, determining components of the transaction data, and formatting the transaction data for processing. In some embodiments, the computing server 110 may manage the approval process of a transaction and may receive the user account during the transaction. For example, the transaction payload (e.g., a credit card transaction) may be sent to the computing server 110 for approval because the transaction may be completed. As such, the computing server 110 may receive a copy of the transaction data. In some embodiments, the transaction data may be received in other ways such as from email of a receipt being forwarded, from a reimbursement request, a bank statement, and a transaction payload that is forwarded by another entity such as from a third-party named entity or from a transaction terminal 160.

In some embodiments, in response to a purchase or a spending event involving the user's card, the computer server 110 may identify the event as a transaction. Various methodologies, subject to the specifics of the payment network and the financial institution, may facilitate the detection process. For instance, a merchant may record the transaction at a point of sale and communicate this transaction data through a payment network to the user's bank (as depicted by the transaction terminal 160 in FIG. 1). The transaction data may include information necessary for processing and authorizing the transaction, such as transaction time, user account information, merchant identification, location, and transaction amount, among others. Post verification and approval of the transaction details by the user's bank, the transaction is executed, and the data pertaining to the transaction is relayed back to the computing server 110. The computing server 110 can store this transaction data in the data store 120 for additional processing steps, which may include identifying the constituents of the transaction data and formatting it for further processing.

The computing server 110 may determine the components of the transaction data, including, among other elements, the transaction amount, the date and time of the transaction, the merchant, the location, and the user account used for the transaction. Each of these components may be extracted and isolated from the transaction data by the computing server 110. Each of these components offers insights about the transaction, providing the computing server 110 with sufficient context and detail to accurately assign it to the appropriate rule or budget category. For example, the transaction amount may refer to the total cost of goods or services associated with the transaction. The date and time of the transaction may provide the exact timestamp of when the transaction occurred, delivering contextual insights that may be important when understanding user spending habits and patterns. The merchant data may include the name and type of the business where the transaction took place and may be useful for categorizing transactions (e.g., restaurants, wellness, professional services). The location of the transaction may be the geographic area where the transaction occurred and may be a valuable component, especially when dealing with travel-related expenses or distinguishing between local and international transactions. If the user has more than one account, the specific account utilized for the transaction may be identified by the computer server 110.

The computing server 110 may format the transaction data through normalization, feature extraction, encoding, cleaning, and/or reshaping processes. The normalization process may be used to bring all transaction data onto a common scale, thereby maintaining uniformity in the dataset. For example, the normalization process may standardize the currency in monetary transactions. The feature extraction process may identify and extract features from the transaction data such as the date and time, merchant data, transaction amount, and the user account that was used. The transaction data may be encoded wherein categorical data may be converted into a format that could be interoperable for system processing. For instance, merchant names, which may be usually in text format, may be encoded into numerical identifiers to make them easier for machine-learning algorithms to work with. The data cleaning process may correct incomplete, erroneous, irrelevant, duplicated, and/or improperly formatted data for quality and reliability purposes. The process of data reshaping may convert the data into a particular data structure or format for further processing.

Continuing with reference to FIG. 3, in some embodiments, the computing server 110 may generate 320 a first embedding from the transaction data. In some embodiments, the embedding is an embedding vector located in a latent space of a first machine-learned model. The latent space may be one of the spaces in a hidden layer of the first machine-learned model.

In one embodiment, the computing server 110 generates an embedding representation that includes latent features of the transaction data. These latent features may be based on the components of the transaction data transformed into a machine-interpretable format. For example, the components of the transaction data may include the transaction amount, date and time, merchant details, location, and which user account may be used as previously mentioned. The computing server 110 may extract these features and input the features into the first machine-learned model to generate an embedding. Alternatively, or additionally, the computing server 110 may input the transaction data payload or part of the payload as a series of strings and allow the first machine-learned model to generate an embedding without the machine-learned model performing any pre-processing. A description of various embodiments of the machine-learned model is provided in the following paragraphs under the section Machine Learning Models. The machine-learned model may transform feature representations into a form that can be plotted in an N-dimensional space, known as the latent space. The transformed representation is called an embedding, so in this case, it is the first embedding.

The latent space may refer to an N-dimensional space (e.g., N>10) which may be part of a hidden layer of the machine-learned model to represent the input data. The dimensions of the latent space are called latent variables or latent dimensions. These latent variables may encode different properties of the transaction data. The machine-learned model may process and understand the similarities and differences between various transactions. Transactions with similar characteristics may be positioned closer to each other, allowing for easy identification of similar transactions for comparison purposes, and conversely, those that are dissimilar may be farther apart. In one embodiment, the first embedding may have a particular position within this latent space. The position may not be arbitrary and may be determined by the characteristics of the transaction data.

In some embodiments, the latent space may be a multi-dimensional space where each dimension corresponds to a latent variable. The machine-learned model may transform the representations into the first embedding, indexing each of them in this multi-dimensional space. The positioning of this first embedding within the latent space may be based on the training of the machine-learned model.

In some embodiments, the computing server 110 may perform feature extraction on the transaction data. The computing server 110 may take the components of the transaction data and transform the components into features. The transformed data may include various data points like the transaction amount, the date and time of the transaction, merchant details, and any counter-party information associated with the transaction. After the data is converted into a feature vector, the first machine-learned model may encode the feature vector as an embedding. In other embodiments, the computing server 110 may input the entire transaction data or part of the data, unprocessed, to the first machine-learned model to generate the first embedding.

Continuing with reference to FIG. 3, in some embodiments, the computing server 110 may identify 330 a set of past transactions of the user. The computing server 110 may identify a set of past transactions by generating second embeddings of past transactions of the user, comparing the second embeddings of the past transactions to the first embedding in the latent space, and identifying the set of past transactions that are similar to the transaction based on comparing the second embedding to the first embedding.

In some embodiments, the computing server 110 may generate the second embeddings of the past transactions of the user by retrieving the historical transaction data of the user and converting the historical transaction data of the user into embeddings by the first machine-learned model. The computing server 110 may retrieve the historical transaction data of the user, which may be stored in the data store 120 of FIG. 1. This data may contain information about any prior transactions made by the user, including details about the transaction's amount, date and time, merchant, user account used, and any counter-party information. For example, the historical transaction data of the user may include any characteristic of the past transactions and/or assigned categories of the past transactions. After the historical transaction data has been gathered, the computing server 110 generates embeddings similar to the way how the first embedding is generated. The order of generation of the first embedding and second embedding may be reversed. For example, the second embeddings that represent the historical transactions may be pre-generated and stored in a data store.

In some embodiments, the second embeddings may be compared to the first embedding in the latent space of the first machine-learned model. Transactions with similar characteristics in the past are represented by embeddings that are close to each other in the latent space, hence facilitating differentiation and classification of subsequent transactions. Based on the comparison of the first and second embeddings, the server may identify the set of past transactions that are most similar to the current transaction based on their corresponding embeddings. This set of similar past transactions may be used to compile an appropriate prompt that the machine-learned language model may use to determine which category or budget allocation the current transaction falls under.

In some embodiments, the computing server 110 may compare the second embeddings of the past transactions to the first embedding in the latent space by retrieving the first embedding and the second embedding in the latent space and computing a distance between the first embedding and each of the second embeddings. The distance between the first embedding and each of the second embeddings may be a measure of closeness between embeddings in the latent space representing how similar the transaction is to each of the past transactions.

The computing server 110 may retrieve the first and second embeddings from the latent space of the trained machine-learned model. Having retrieved the necessary embeddings, the computing server 110 may calculate the distances between the first embedding (representing the current transaction) and each of the second embeddings (representing the past transactions). The calculation metric may be a form of distance that takes into account the multi-dimensional nature of the latent space. For example, in machine learning and data processing, the term calculation metric may refer to a mathematical measure that is used to assess the similarity or difference between data points. In this case, the calculation metric is a measure of the distance between different embeddings in the latent space. For example, the distance may not be a physical one but a measure of how similar or different the data points (in this context, transactions) are. As such, there are different forms of calculation metrics that may be used, each with its own benefits. Examples of calculation metrics may include Euclidean distance and cosine similarity, among others.

Each computed distance may be a measure of how similar or dissimilar the current transaction is to each of the past transactions. In the latent space, transactions with similar characteristics (amount, merchant, account used, etc.) are located closer together. So, the smaller the distance between two embeddings, the higher the similarity between the corresponding transactions.

In some embodiments, the Euclidean distance between the first embedding (current transaction) and each of the second embeddings (past transactions) may be computed. For example, this is effectively calculating the straight-line distance between the two points in the multi-dimensional latent space. Transactions resulting in points that are close together (i.e., have a low Euclidean distance) are seen as more similar. So, the computing server 110 may identify past transactions that are most similar to the current one by selecting those whose embeddings are closer based on Euclidean distance. In some embodiments, cosine similarity measures the orientation rather than the magnitude of distance between two points in a multi-dimensional space, essentially calculating the cosine of the angle between the two points. In the context of transaction data embeddings, it may be useful when the overall scale of transactions varies greatly, but their relative proportions are similar. For instance, if an individual usually spends about the same proportion of their income on groceries and utilities, but the absolute amounts vary wildly due to income instability, cosine similarity may capture the consistent proportionality more effectively than Euclidean distance. By comparing these distances, the computing server 110 may identify the set of past transactions that are most similar to the current transaction. In other words, it rounds up the past transactions whose embeddings in the latent space are nearest to the embedding of the current transaction.

In some embodiments, the computing server 110 may identify the set of past transactions that are similar to the transaction based on comparing the second embeddings to the first embedding by generating a list of past transactions based on the distance between the first embedding and each of the second embeddings, wherein a number of past transactions with their second embeddings closer to the first embedding are selected.

For example, a list of past transactions may be sorted from shortest distance to longest distance from the current transaction's embedding. The sorting may rank the past transactions on the basis of their similarity to the current transaction. Transactions with a shorter distance may be considered more similar as they are closer in the latent space. Following the sorting, a selection may be made from the list. For example, a predetermined number of past transactions may be chosen, starting from those with their second embeddings closest to the first embedding. For example, if the computing server 110 is set to select five past transactions, it may choose the top five past transactions from the sorted list, which are the ones determined to be most similar to the current transaction.

The first machine-learned model may be a neural network or a machine-learned language model. The first machine-learned model may be the same or a different model than the machine-learned language model used in step 350.

Continuing with reference to FIG. 3, in some embodiments, the computing server 110 may compile 340 a prompt that includes the transaction and the set of past transactions of the user. The computing server 110 may compile the prompt for a machine-learned language model for a prediction about the categorization of the new transaction. For both the new transaction and the set of similar past transactions, relevant information may be extracted. This may include details of the merchant, date and time, the amount spent, and the spending category previously assigned to past transactions. The specifics of the extracted information may vary based on the model's structure and what it has been trained to consider as significant. These transaction details may then be transformed into a suitable format, often in natural language, to be understood by the language model. Once the data is ready, the computing server 110 may combine it to form a comprehensive prompt. In some embodiments, no pre-processing is performed and the target transaction data is included in the prompt without feature extraction.

The prompt may include a description or a direct copy of the current transaction data with the context of similar past transactions used as examples for the machine-learned language model. In some embodiments, each similar past transaction is associated with a past allocation label indicating how the past transaction is allocated to a particular transaction rule. The prompt may include the details of the target transaction, the details of similar past transactions, and other relevant characteristics. This data may be formulated into a natural language string, which provides the necessary context for a machine-learned language model. For example, a prompt may include the following: The user just spent $7 at Starbucks. In the past, they have spent $8 at Starbucks categorized as coffee with a colleague, $10 at Java House categorized as coffee with a colleague, and $15 at Eat Out categorized as lunch. Predict the spending category for the new transaction. For example, a prompt may also look like this: The user has previously categorized their Starbucks transactions under the Food budget. The latest transaction is a $5 purchase from Starbucks. In some embodiments, the prompt may also include the target transaction data in the unprocessed or barely processed format, past transaction data in unprocessed or barely processed formats, and labels on how the past transactions are allocated.

In some embodiments, the computing server 110 may compile the prompt that includes the transaction and the set of past transactions of the user by extracting data from the transaction and the set of past transactions and generating the prompt based on the extracted data. The extracted data may include any one of the purchase details, merchant name, date and time, transaction amount, and, for past transactions, their assigned spending categories. The prompt may be a data structure that describes the transaction in the context of similar past transactions. The data structure may be formatted into a natural language for processing by a machine-learned language model. The compilation process may start with the extraction of data from the current transaction and the selected similar past transactions. The data points extracted may include details such as the associated merchant, transaction amount, date and time, and for past transactions, their assigned budget categories.

In some embodiments, the computing server 110 may organize the data into a coherent data structure. This data structure may describe the existing transaction in the context of similar past transactions. For example, the data structure generates an expense narrative that places the present transaction within the framework of the user's past, related transaction behavior. The data structure may provide a data format for the machine-learned model to comprehend the context and draw informed predictions. Finally, the data structure is transformed into a prompt, which is a natural language version of the data. This step may include the conversion of the data structure into a format that the machine-learned language model can understand and process. The prompt, in an accessible format, provides the necessary input for further processing and analysis by the machine-learned language model.

Continuing with reference to FIG. 3, in some embodiments, the computing server 110 may input 350 the prompt to a machine-learned language model to request the machine-learned language model to allocate the transaction into one of the transaction rules. Having compiled the prompt that includes details about the current transaction and similar past transactions, the computing server 110 may input the natural language formatted prompt into a machine-learned language model. The model may be trained on vast amounts of language data and thus may understand and generate human-like text. For example, the model may be trained to perform tasks such as text generation or classification based on the training data it was exposed to. The machine-learned language model may process the prompt input by analyzing the details and the rules, which are guidelines regarding spending limits or category allocations specific to each user. The model may use its training to understand and process these rules in the context of the transaction details provided in the prompt. For example, the model may be trained to understand the rules, limitations, and patterns deriving from the transaction history of a user and their allocated budgets.

The machine-learned language model may generate a response by providing a suitable user-specific output for the current transaction. This output allocation may be based on the language model's analysis of the prompt. For example, if the transaction relates to a restaurant payment and the user has a transaction rule about lunch expenses, the model may suggest allocating this transaction to the lunch rule. The machine-learned language model may be a model that is provided by the model serving system 170.

Continuing with reference to FIG. 3, in some embodiments, computing server 110 may receive 360 an output from the machine-learned language model. For example, in response to the prompt, the model generates an output based on its processing. The output may be the model's prediction or decision about where to allocate (or categorize) the current transaction amongst the user's budgets. The output may be structured in a format that can be used for further processing, such as a JSON object containing the aligned budget name, a confidence score, and other relevant information. The computing server 110 receives or captures this output from the machine-learned model. An example output of the machine learning model may be Transaction: $7 at Starbucks; Predicted category: Coffee with a colleague; Confidence score: 0.85.

Continuing with reference to FIG. 3, in some embodiments, the computing server 110 may allocate 370 the transaction data to one of the rules based on the output from the machine-learned language model. Once the machine-learned model generates its output and the computing server 110 receives the output, the computing server 110 may perform allocation of the transaction to one of the rules based on this output.

The computing server 110 may obtain the output from the machine-learned model, which includes the predicted category and confidence score. For example, the output may be ‘Coffee with a colleague’ with a confidence score of 85%. The computing server 110 may evaluate the confidence score against a set threshold. The threshold may be set to provide accurate categorization. For example, the threshold is 80%. If the confidence score exceeds this threshold, the computing server 110 may proceed with the automated allocation. If not, the transaction may be flagged for manual review. For example, the computing server 110 may request the user of the account to review and annotate the transaction by transmitting a message containing the annotation request to the user through a communication channel comprising an SMS message, email, or SaaS platform.

The computing server 110 may search through the user's specific budgeting rules to match a predicted category with the rules. These rules may be user-specified categories for transactions with guidelines on how to allocate money for each category.

The computing server 110 finds a match between the predicted category and a specific rule. In turn, the computing server 110 may allocate the transaction to that specific rule. For example, the computing server 110 may allocate the Starbucks transaction to the ‘Coffee with a colleague’ category (or spend allocation category). This might involve adding the transaction amount to the total spending in this category and/or subtracting it from the user's total available budget to generate an up-to-date budget. The computing server 110 may provide feedback to the user, informing them about the automatic allocation. This may include information about the transaction, predicted category, confidence score, and/or any changes made to the budget. If the user corrects or modifies the automatic allocation, the computing server 110 may input this feedback into the machine-learned model to improve future predictions. This makes the process more accurate over time.

In some embodiments, the computing server 110 may allocate the transaction data to one of the rules based on the output from the machine-learned language model by comparing the output from the machine-learned language model to a dataset of spend allocations of the user, determining if the output from the machine-learned language model matches a spend allocation data within the dataset of the spend allocations of the user, and if the output from the machine-learned model matches a spend allocation data within the dataset of the spend allocations of the user, allocating the transaction data to a spend allocation associated with the matched spend allocation data.

In this case, the output from the machine-learned language model (i.e., the prediction of where a transaction should be classified) is compared to a dataset of spend allocations for the user. If the model's output matches one of the spend allocation data within the user's dataset of spend allocations, it is a signal that the model's prediction is correct. This matching step provides the necessary validation to proceed. If a match is found (that is, the model's prediction aligns with a user's past behavior), the transaction data (which is the new transaction that needs to be classified) will be allocated to the relevant spend allocation that matches the output of the model. Thus, the transaction will be categorized in the same way that similar transactions were classified in the past, in line with the rules.

In some embodiments, the computing server 110 may allocate the transaction data to the spend allocation associated with the matched spend allocation data by identifying a confidence score of the output from the machine-learned language model, comparing the confidence score of the output from the machine-learned language model to a predetermined threshold, and if the confidence score of the output from the machine-learned model exceeds the predetermined threshold, allocating the transaction data to the spend allocation associated with the matched spend allocation data.

For example, the machine-learned language model may determine a confidence score along with its output. The confidence score is a probability value that represents the model's certainty in its current prediction. Higher values can indicate greater confidence. A predetermined threshold may be set by the computing server 110. The threshold may be chosen based on the system's design or past performance, which may serve as a comparison point for the confidence score. If the confidence score of the output from the machine-learned model exceeds this threshold, it means that the machine's prediction is reliable enough (as per the system's design parameters) and so, the new transaction may be allocated to the relevant spend category as determined by the model. This process may provide a more refined allocation decision by factoring in the model's confidence. The confidence threshold may be adjusted to meet different reliability demands, allowing for a customizable transaction management system.

In some embodiments, if the output from the machine-learned language model does not match one allocation data within the dataset of the spend allocations of the user, the computing server 110 may identify a subset of the dataset of spend allocations of the user that is close or similar to the output from the machine-learned model by generating, in a latent space of a machine-learned model, an embedding of the output from the machine-learned model and an embedding of each spend allocation data in the dataset of spend allocations of the user, comparing the embedding of the output from the machine-learned model and the embedding of each spend allocation data in the dataset of spend allocations of the user in the latent space, and identifying the subset of the dataset of spend allocations of the user that is close or similar to the output from the machine-learned model based on comparing the embedding of the output from the machine-learned model and the embedding of each spend allocation data in the dataset of spend allocations of the user in the latent space. The computing server 110 may then allocate the transaction data to a spend allocation of the subset of the dataset of spend allocations of the user that is close to or similar to the output from the machine-learned model.

This process may represent a contingency plan for scenarios where the output from the machine-learned language model does not directly match any of the user's previous transaction categories (i.e., spend allocation) in the dataset. In such cases, an approximate match based on similarity is sought instead.

In some embodiments, the output from the initial machine-learned model and the entries of the dataset of spend allocations are transformed into feature representations, known as embeddings, in a latent space. This latent space is a high-dimensional space derived from the training data where similar transactions have nearby coordinates (are close together). The embeddings of the model output and each of the spend allocation data in the latent space are compared. The distance between embeddings in this latent space provides a measure of how similar the represented transactions are. From this comparison, a subset of spend allocations that are close to or similar to the output from the machine-learned model is identified. So even if there is not a perfect match, the most similar transaction categories can still be found based on their embeddings in the latent space. Once the most similar spend allocation is identified, the new transaction may be allocated to this calculated spending category. The aim of this process is to tender flexibility and a backup strategy in scenarios where a direct match is not found, using embeddings to identify the closest match and keep the spend allocation as accurate as possible.

In some embodiment, the computing server 110 may allocate the transaction data to one of the rules based on the output from the machine-learned language model by requesting the user of the account to annotate the transaction, receiving, from the user, the annotations for the transaction through the communication channel, allocating the transaction data to a spend allocation based on the annotations for the transaction received from the user. The computer server 110 may request the user to annotate the transactions by identifying the user associated with the transaction and transmitting a message containing the annotation request to the user through a communication channel comprising an SMS message, email, or SaaS platform.

For example, the computing server 110 may flag a transaction for manual categorization. It sends a request to the user associated with the transaction asking them to annotate it, essentially asking the user to classify the transaction to their preferred category manually. This annotation request may be transmitted via any one, or possibly multiple, communication channels. These channels may range from SMS or email to SaaS platforms. The user may respond to this annotation request by providing the necessary information through the same communication channels (as shown in FIGS. 5A-5B and 6). In these scenarios, the user's response may contain their chosen categorization or annotation for the transaction.

In some embodiments, the machine-learned language model may also output top N candidates of rules to which the target transaction should be assigned. In turn, the computing server 110 may send a communication (e.g., an SMS message) to the user with a list of choices for the user to select the right rule. In some embodiments, the computing server 110 may include a default selection (the most likely rule) and ask the user if the proposed selection is correct. If not, the computing server 110 may provide additional candidates in the communications.

In response to the user's response, the computing server 110 allocates the transaction data based on the user's provided annotation. In other words, the transaction is categorized according to the user's specified category. In this embodiment, the user's feedback is helpful in identifying the correct spend allocation. This process leverages the user's understanding of their own spending behavior to enhance the system's eventual accuracy and cater to cases where automated allocation may not be sufficient or accurate.

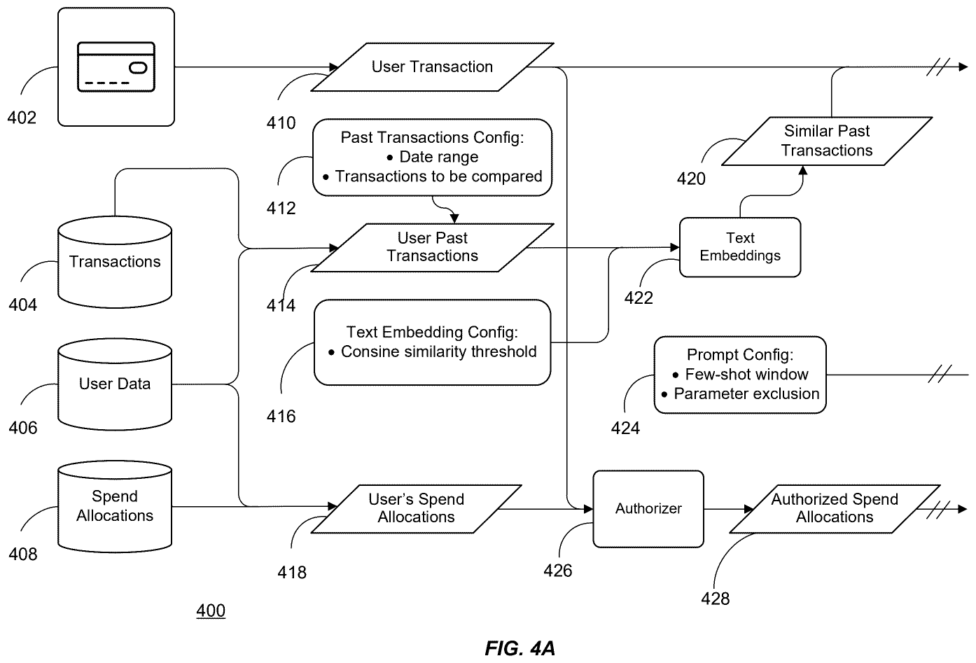

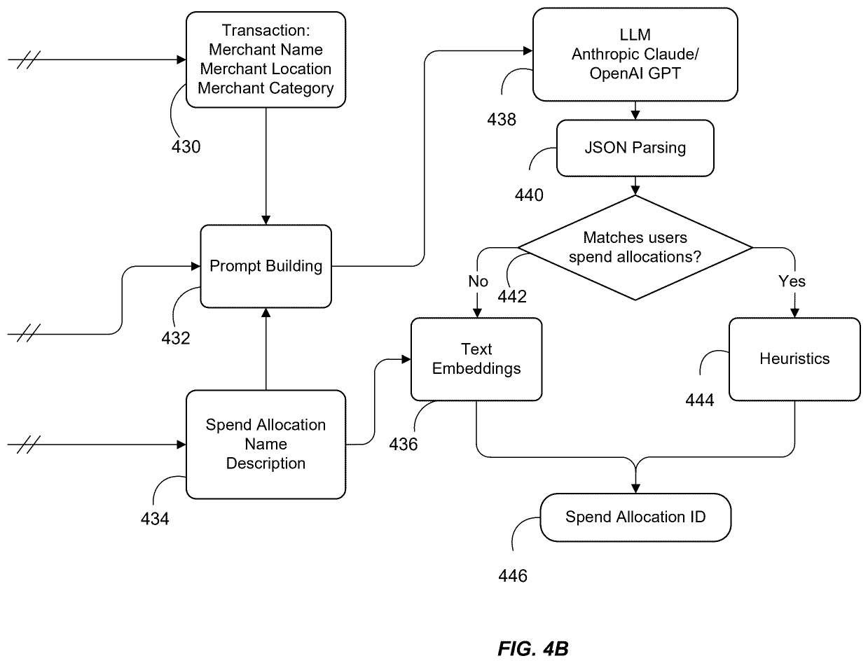

FIGS. 4A-4B are flowcharts depicting an example process 400 for automatic transaction matching, in accordance with some embodiments. At 402, the computing server receives the details of a new transaction performed by a user from a transaction terminal. From this new transaction, the computer server may extract transaction data 410, including transaction amount, date and time, the merchant involved, counter-party information, location, and the specific user account used. The transaction terminal may be an interface that facilitates an end user's transaction device to conduct electronic fund transfers with a third party, which could be a named entity like businesses or individuals. The transaction terminal may oversee and/or mediate a broad spectrum of electronic fund transfers. These transactions may encompass many methods, which include but are not limited to credit card payments, ATM transfers, direct deposits or debits, online bank transfers, peer-to-peer transactions, instant messaging fund transfers, wire transfers or electronic bill payments, and cryptocurrency or blockchain transfers.

A transaction data store 402 is a storage system designed to securely hold and manage transaction data that the computing server receives from various transaction terminals. This data may include but is not limited to, details about the transaction such as the amount, date, and time, the merchant involved, details about the counterparty, the location of the transaction, and the specific user account used. This data may be collected from a wide array of transaction types, including credit card payments, ATM transfers, direct deposits, debits, online transfers, peer-to-peer transactions, instant messaging fund transfers, wire transfers, electronic bill payments, and cryptocurrency or blockchain transfers. The transaction data store not only stores transaction data for historical records but also provides it for processing, analysis, and comparison when required.

A user data store 406 is a storage system designed to securely hold and manage personal and profile data related to the users of the system. The user data store 406 holds user-specific details that help the system in processing and categorizing transactions. Information stored in the user data store typically includes but isn't limited to: the user's profile details, such as their name, contact information, financial account numbers, and other relevant identifiers; information regarding the user's spending behavior, like their allocated budgets and imposed restrictions; contextual data, for instance, whether the user is traveling, their current time zone, their department within an organization and their physical location; and users' past transactions and successful category allocations.

A spend allocation data store is a storage system designed to securely hold information related to the budget allocations each user has within the system. These budget allocations stem from the predefined rules determined by, for instance, their employer or financial team. These rules guide the categorization and/or allocation of user's transactions. The spend allocation data store may include specific budgets assigned to a user for different spending categories such as wellness benefits, lunch, business trips, and so on; unique identifiers linked to each specific budget for easy retrieval and management; restrictions and conditions related to each budget allocation, such as the maximum amount available in each category and the conditions under which it can be used; and historical data of how previous transactions have been allocated to the budgets. In practice, by comparing new transactions to a user's spend allocations, the computing server may determine the most appropriate category for each new transaction.

In response to a new transaction, the computing server 110 may identify a set of past transactions 414 from the transaction data store 404 and/or the user data store 406. The computing server may use a filter 412 to narrow the set of past transactions 414. For example, using filter 412, the computing server 110 may specify a date range, a transaction type, or other filters to narrow down the selection of transactions. The computing server may provide a configuration tool 416 to specify parameters for creating the embeddings. The configuration tool 416 may include a user interface or application provided by the computing server that allows an administrator to define the size of the embedding vector or choose a similarity measure for comparing embeddings (like cosine similarity). The administrator may also set a threshold for the similarity measure to determine which past transactions are considered “similar” to the current transaction.

To identify the set of similar past transactions 420, the computing server may create embeddings 422 of the past transactions 414 and compare these in latent space. Transactions 414 whose embeddings are closest to the embedding of the new transaction 410 are assumed to be similar. The computing server then combines at 430 the details of the current transaction 410 with the identified similar past transactions 420. This compiled set of transaction data provides a set of well-rounded, historical context for the current transaction.

The set of compiled transaction data is sent to a prompt building module 432. This module is designed to format the provided data into a prompt which can be processed by a machine-learned language model. This includes transforming the collected data into natural language or a structured format that the machine learning model can easily process and understand.

The computing server can access the user's specific spend allocations 418 from the spend allocation data store 408 and/or the user data store 406. The allocations 418 may include specific budgets for different spending categories, such as wellness benefits, lunch, business trips, and others, set by the finance team or another entity. The computing server can combine the details of the current transaction 410 with the retrieved spend allocations 418. This combined data structure can provide details about the transaction and also details about the possible spending categories under which the transaction could potentially fall. The combined data is sent to an authorizer module 428. The authorizer module 428 can determine which of the user's spend allocations are authorized for the current user transaction 410. Based on factors like the user's set budgets and restrictions, the transaction details, and any other contextual data, the authorizer module 428 identifies the possible authorized spend allocations that the new transaction can be classified under. The computing server can extract the details 434 such as the name and description of the authorized spend allocations 428 and transmit all the details to the prompt building module 432.

The computing server may include a configuration tool 424 to specify parameters for building a prompt. Configuration tool 424 may include a user interface or application for specifying certain parameters for building a prompt. The configuration tool 424 allows users to exclude certain parameters or factors from being considered when the prompt building module 432 constructs the prompt. For example, if certain data points from the transaction details or user's context are not relevant or useful for a certain category of transactions, they can be excluded to make the machined-learned model's predictions more precise and targeted. For example, the configuration tool 424 allows users to select a ‘few-shot window’ for setting the number of past transactions the prompt building module 432 may consider when determining the building of the prompt.

The prompt building module 432 generates a prompt that is understood by the machine-learned language model. The prompt may be generated from data like the current and past transaction details, user's behaviors authorized spend allocation details, and other relevant parameters. After a prompt is generated by the prompt building module 432, the computing server inputs the prompt into a machine-learned model 438. The machined-learned model 438 is designed to process the prompt, i.e., the data within it, and generate an output. The generated output is used to make a decision about how to classify the transaction, allocating the transaction to a specific budget category.

After this output is generated, it may be inputted into a parsing module to convert the data from the model format into a structured format such as JSON format. The JSON formatting may include organizing the data into easy-to-read key/value pairs. For example, the output may be converted into the following JSON format: budget category: wellness; confidence score: 0.98. In this output, the budget category and confidence score are keys and wellness and 0.98 are their associated values. This way, the output is converted into a format that is easy to understand.

After the machine-learned model 438 generates an output and the output is parsed by the parsing module 440 into a readable and suitable format (e.g., JSON object), the next step involves matching or classifying the current transaction to specific user spend allocations or budgets by using the machine-learned model output. The computing server attempts 442 to match the current transaction 410 to the user spend allocations 428 by considering the parsed output of the machine-learned model, which may likely indicate the predicted allocation for the transaction based on the model's learned patterns and rules. Successful matching may include transaction 410 being recognized as fitting within one of the predefined user budget categories of the user spend allocations 428. This step validates if the computed allocation from the machine-learned model exists among the user's predefined authorized spend allocations 428. After successful matching of the transaction to one of the user-defined budget categories, a heuristics module 444 can be used to overcome the machine-learned model limitations. For example, the heuristics module 444 can set a minimum confidence level for spend allocation. If the model's confidence level is not high enough, the computing server may use the heuristic module 444 to override or revise the allocation. For example, in cases where a transaction falls under multiple categories, each with similar confidence levels from the machine learning model, the heuristic module 444 can incorporate predefined rules to break the tie to provide a singular category assignment.

After a review of the match by the heuristics module 444, the computing server assigns a specific spend allocation ID 446 to the transaction 410. The spend allocation ID may be a unique identifier related to the specific budget category the transaction falls under.

If a direct match is not found in step 442, the computing server converts the parsed output from the machine-learned model and each of the authorized spend allocations into embeddings 436. These embeddings 436 are generated in the same dimensional, allowing for direct comparison. The computing server then computes the similarity between the parsed machine-learned model output's embedding and each of the authorized spend allocations' embeddings.

The computing server can then identify the authorized spend allocation embedding that is most similar (i.e., closest in the embedding space) to the parsed machine-learned model output's embedding. Based on the embedding comparison, the computing server then categorizes the transaction under this most similar allocation, providing a fallback allocation when direct machine-learned model matching fails. In response to the allocation, the computing server assigns a spend allocation ID 446 to transaction 410.

In some embodiments, if a direct match is not found in step 442, the computing server may send a message to the user to annotate the transaction into a suitable spend allocation. The message may request the user to manually categorize or annotate the transaction. The computing server may select a predefined communication channel such as an SMS, email, or SaaS platform. The selection of the communication channel may depend on user preference or the medium that is most efficient and likely to draw user response in a given context. Afterward, the computing server sends the message to the user. The message may include information about the transaction and present the user with possible categorization options. The message may request the user to annotate or select an appropriate spending category for the transaction. After the user receives the message, they would review the transaction and select the category it fits into. They would then respond with their selected category. Once the user responds, the computing server processes the user's input and categorizes the transaction accordingly. The transaction and its user-specified category may then be added to the system's training data to inform and improve future categorizations.

### Transaction Annotation Interfaces

FIGS. 5A-5B depict an example user interface 500 for processing a transaction using a device of an end user, in accordance with an embodiment. The interface 270 of the computing server 110 may be used to generate the SMS messages as shown in FIGS. 5A-5B and 6. Local applications on the client device may facilitate the display of the SMS. On the interface 500, interactions 510-590 (e.g., SMS messages) may occur between the end user and the computing server 110. The end user can use the client device to receive SMS messages from the computing server 110 and send messages to the computing server 110. The computing server 110 can maintain a profile of the end user at the client profile management engine 210, including contact information such as an email or phone number. The phone number may be the number associated with the client device and may be used to communicate SMS messages with the computing server 110. The interaction 510 shows the computing server 110 providing the details of a transaction to the end user, including the matching of the transaction to a spend allocation. The interaction 520 shows the computing server 110 asking the end user to provide information such as a photo of a receipt regarding a transaction. The interaction 530 shows the end user providing the photo of the receipt. The interactions 540-550 shows the processing of the receipt by the computing server 110. The interaction 560 shows the computing server 110 providing successful processing of the receipt. The interaction 570 shows the computing server 110 asking the end user to provide a reason for the transaction. The interaction 580 shows the end user providing the reason for the transaction. The interaction 590 shows the computing server 110 providing a successful addition of the reason for the transaction.

FIG. 6 depicts an example user interface 600 for processing a transaction using a device of an end user, in accordance with an embodiment. The user interface 600 is generated and works the same way as the user interface 500 in FIGS. 5A-5B. The interaction 610 shows the computing server 110 providing the details of a transaction to the end user, including the matching of the transaction to a spend allocation, and providing the user the option to annotate and/or change the spend allocation. The interaction 620 shows the end user requesting a change of the spend allocation. The interaction 630 shows the computing server 110 providing allocation options to the end user. The interaction 640 shows the end user selecting one of the options provided in interaction 630. The interaction 650 shows the computing server 110 allocation of the transaction to the option selected by the end user in the interaction 640.

### Machine Learning Models

In various embodiments, a wide variety of machine-learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used.

In various embodiments, the training techniques for a machine learning model may be supervised, semi-supervised, or unsupervised. In supervised learning, the machine learning models may be trained with a set of training samples that are labeled. Any one of a number of supervised learning techniques may be used to train the models. Examples include, but are not limited to, random forests and other ensemble learning techniques, support vector machines (SVM), and logistic regression. In some cases, an unsupervised learning technique may be used, where the samples used in training are not labeled. Various unsupervised learning techniques such as clustering may be used.

In some embodiments, the machine-learned model may be a large language model (LLM) that is specifically designed to generate human-like text. This machine-learned model is part of a broader category of machine-learning models known as transformer models, which allow them to understand and process a natural language such as the language that humans naturally use to communicate. LLMs are categorized as large because they have numerous parameters (billions in some cases) that they adjust during the training process. The size of these models helps them better understand and generate human-like text because they can learn from a vast amount of data, memorizing a larger amount of information about language patterns and structures.

A generative pretrained transformer (GPT) is an example of an LLM. It may be trained on diverse data sets in an unsupervised learning manner, which means no explicit instructions or labels were provided to it during the training phase. Instead, it learned patterns and relationships from the data it was trained on and used these patterns to generate text that resembles human-written content. In practice, these models take a prompt (a piece of text input) and generate a text continuation. They predict the next part of a text based on the patterns they have learned and the specific prompt provided. LLMs have the ability to generate diverse types of text in a human-like manner, ranging from simple sentences to full articles. They may be used for a variety of applications such as draft generation, brainstorming ideas, writing assistance, and even in complex tasks like generating code or translating languages.

In the context of allocating transactions to certain rules, the LLM may interpret, understand and predict transaction classifications based on the data it is provided. For example, the LLM may be a prompt, which includes structured data about the transaction, past transactions, and the rules and/or budgets. The LLM may process the prompt and generate an output that allocates the transaction to one of the rules. This machine-learned model may understand complex patterns in transaction data by learning from past transactions rules. It may operate by comparing the current transaction with past transactions and the rules to determine the most appropriate allocation.

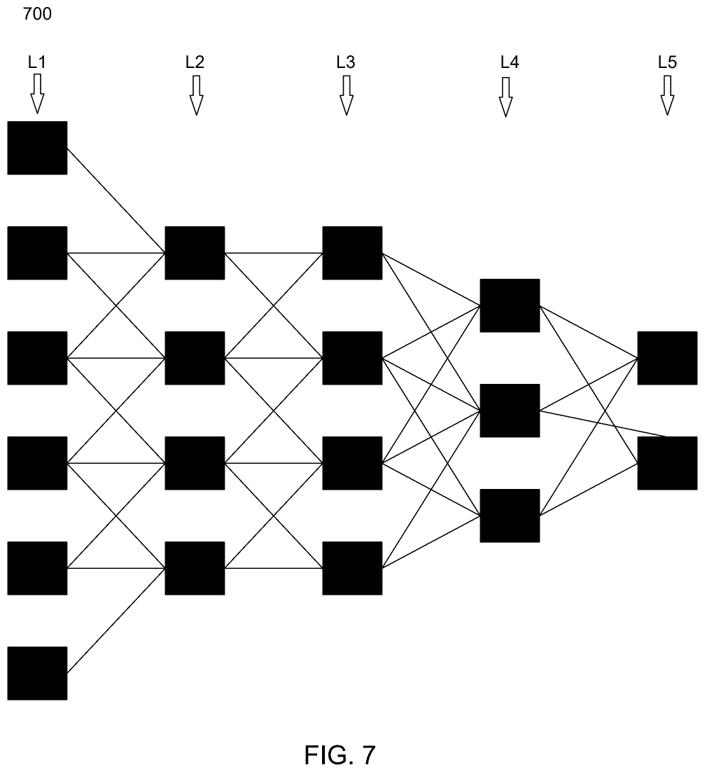

FIG. 7 shows an example machine-learned model 700 that may be used to generate an embedding. The first machine-learned model and the machine-learned language model discussed in FIGS. 3 and 4 may include the architecture of machine-learned model 700. The network model shown in FIG. 7, also referred to as a deep neural network, comprises a plurality of layers (e.g., layers L1 through L5), with each of the layers including one or more nodes. Each node has an input and an output and is associated with a set of instructions corresponding to the computation performed by the node. The set of instructions corresponding to the nodes of the network may be executed by one or more computer processors.

Each connection between nodes in the machine-learned model 700 may be represented by a weight (e.g., numerical parameter determined through a training process). In some embodiments, the connection between two nodes in the machine-learned model 700 is a network characteristic. The weight of the connection may represent the strength of the connection. In some embodiments, connections between a node of one level in the machine-learned model 700 are limited to connections between the node in the level of the machine-learned model 700 and one or more nodes in another level that is adjacent to the level including the node. In some embodiments, network characteristics include the weights of the connection between nodes of the neural network. The network characteristics may be any values or parameters associated with connections of nodes of the neural network.

A first layer of the machine-learned model 700 (e.g., layer L1 in FIG. 7) may be referred to as an input layer, while a last layer (e.g., layer L5 in FIG. 7) may be referred to an output layer. The remaining layers (layers L2, L3, L4) of the machine-learned model 700 are referred to are hidden layers. Nodes of the input layer are correspondingly referred to as input nodes; nodes of the output layer are referred to as output nodes, and nodes of the hidden layers are referred to as hidden nodes. Nodes of a layer provide input to another layer and may receive input from another layer. For example, nodes of each hidden layer (L2, L3, L4) are associated with two layers (a previous layer and a next layer). A hidden layer (L2, L3, L4) receives an output of a previous layer as input and provides an output generated by the hidden layer as an input to a next layer. For example, nodes of hidden layer L3 receive input from the previous layer L2 and provide input to the next layer L4.

The layers of the machine-learned model 700 are configured to identify one or more embeddings of transaction data. For example, an output of the last hidden layer of the machine-learned model 700 (e.g., the last layer before the output layer, illustrated in FIG. 7 as layer L4) indicates one or more embeddings of a transaction. An embedding may be a high-dimensional vector. In some embodiments, the embeddings may also be extracted from any intermediate layer.

In some embodiments, the weights between different nodes in the machine-learned model 700 may be updated using machine learning techniques. For example, the machine-learned model 700 may be provided with training data identifying transactions with a label of transaction rule assignment applied to each rule. The label applied to a transaction may be based on transaction data of the computing server 110. In some embodiments, the training of the machine-learned model 700 may also be the training or fine tuning of a machine-learned language model. In some embodiments, the training data comprises a set of feature vectors corresponding to a transaction, with each feature vector of the training data associated with a corresponding label related to a transaction rule. Features of a transaction of the training set determined by the machine-learned model 700 are compared from the output layer of the network model and the label applied to the transaction of the training set, and the comparison is used to modify one or more weights between different nodes in the machine-learned model 700, modifying an embedding output by the machine-learned model 700 for the transaction.

Training of a machine-learned model 700 may include an iterative process that includes iterations of making determinations, monitoring the performance of the machine-learned model 700 using the objective function, and backpropagation to adjust the weights (e.g., weights, kernel values, coefficients) in various nodes. For example, a computing device may receive a training set that includes training data and labels assignments. The computing device, in a forward propagation, may use the machine-learned model 700 to generate predicted the label. The computing device may compare the predicted label with the labels of the training sample. The computing device may adjust, in a backpropagation, the weights of the machine-learned model 700 based on the comparison. The computing device backpropagates one or more error terms obtained from one or more loss functions to update a set of parameters of the machine-learned model 700. The backpropagating may be performed through the machine-learned model 700 and one or more of the error terms based on a difference between a label in the training sample and the generated predicted value by the machine-learned model 700.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine-learned model 700 has converged) or after a predetermined number of rounds for a particular set of training samples. The trained machine-learned model 700 can be used for make inference or another suitable task for which the model is trained.

In some embodiments, such as using a language model to generate embedding, training may be performed using an unsupervised learning techniques. Existing models such as those provided by the model serving system 170 may also be used for generating embeddings.

In various embodiments, the training samples described above may be refined and continue to re-train the model, which the model's ability to perform the inference tasks. In some embodiments, this training and re-training processes may repeat, which results in a computer system that continues to improve its functionality through the use-retraining cycle. For example, after the model is trained, multiple rounds of re-training may be performed. The process may include periodically retraining the machine-learned model 700. The periodic retraining may include obtaining an additional set of training data, such as through other sources, by usage of users, and by using the trained machine-learned model 700 to generate additional samples. The additional set of training data and later retraining may be based on updated data describing updated parameters in training samples. The process may also include applying the additional set of training data to the machine-learned model 700 and adjusting parameters of the machine-learned model 700 based on the applying of the additional set of training data to the machine-learned model 700. The additional set of training data may include any features and/or characteristics that are mentioned above.

The computing server 110 may an embedding for a transaction and the embedding may include a multidimensional vector (e.g., N>10) representing the transaction in a latent space. The computing server 110 may use any suitable method for generating an embedding for the query. Example methods for generating the embedding for the query include Word2Vec, GloVE, as a layer in a neural network trained from a training set of documents or other text data, or any other suitable method.

### Computing Machine Architecture

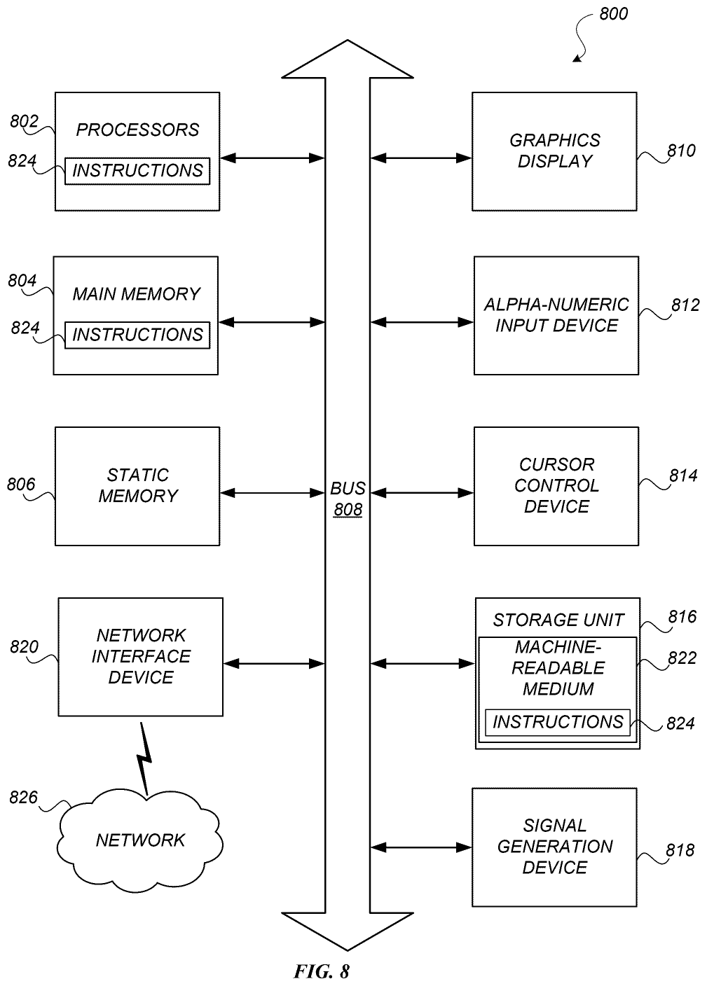

FIG. 8 is a block diagram illustrating components of an example computing machine that is capable of reading instructions from a computer-readable medium and executing them in a processor (or controller). A computer described herein may include a single computing machine shown in FIG. 8, a virtual machine, a distributed computing system that includes multiple nodes of computing machines, or any other suitable arrangement of computing devices.

By way of example, FIG. 8 shows a diagrammatic representation of a computing machine in the example form of a computer system 800 within which instructions 824 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in FIGS. 1 and 2, including but not limited to, the client device 150, the computing server 110, and various engines, interfaces, terminals, and machines shown in FIG. 2. While FIG. 8 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IOT) device, a switch or bridge, or any machine capable of executing instructions 824 that specify actions to be taken by that machine. Further, while only a single machine is illustrated, the terms “machine” and “computer” may also be taken to include any collection of machines that individually or jointly execute instructions 824 to perform any one or more of the methodologies discussed herein.

The example computer system 800 includes one or more processors 802 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 800 may also include a memory 804 that stores computer code including instructions 824 that may cause the processors 802 to perform certain actions when the instructions are executed, directly or indirectly by the processors 802. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 802 and reduce the space required for the memory 804. For example, the database processing techniques and machine learning methods described herein reduce the complexity of the computation of the processors 802 by applying one or more novel techniques that simplify the steps in training, reaching convergence, and generating results of the processors 802. The algorithms described herein also reduce the size of the models and datasets to reduce the storage space requirement for memory 804.

The performance of certain operations may be distributed among more than one processor, not only residing within a single machine but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributively, comprise instructions that, when executed by one or more processors, cause the one or more processors to perform, individually, together, or distributively, the steps of the instructions stored on the one or more computer-readable media. Similarly, a processor comprises one or more processors or processing units that, individually, together, or distributively, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 800 may include a main memory 804, and a static memory 806, which are configured to communicate with each other via a bus 808. The computer system 800 may further include a graphics display unit 810 (e.g., a plasma display panel (PDP), a liquid crystal display (LCD), a projector, or a cathode ray tube (CRT)). The graphics display unit 810, controlled by the processor 802, displays a GUI to display one or more results and data generated by the processes described herein. The computer system 800 may also include an alphanumeric input device 812 (e.g., a keyboard), a cursor control device 814 (e.g., a mouse, a trackball, a joystick, a motion sensor, or other pointing instruments), a storage unit 816 (a hard drive, a solid-state drive, a hybrid drive, a memory disk, etc.), a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium may include any medium that is capable of storing instructions (e.g., instructions 824) for execution by the processors (e.g., processors 802) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g., method, can be claimed in another claim category, e.g., computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter that can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that are issue on an application based hereon. Accordingly, the disclosure of the embodiments is intended to be illustrative, but not limited, of the scope of the patent rights.

What is claimed is:

1. A computer-implemented method, comprising:
receiving transaction data of a transaction associated with a user account of a user, the user being associated with one or more transaction rules, wherein the user has one or more user accounts and the transaction rules impose one or more restrictions on the user that are applied across the one or more user accounts;
generating a first embedding from the transaction data, the first embedding being in a latent space of a first machine-learned model;
identifying a set of past transactions of the user, wherein identifying the set of past transactions of the user comprises:
generating second embeddings of past transactions of the user,
comparing the second embeddings of the past transactions to the first embedding in the latent space, and
identifying the set of past transactions that are similar to the transaction based on comparing the second embeddings to the first embedding;
compiling a prompt that includes the transaction and the set of past transactions of the user;
inputting the prompt to a machine-learned language model to request the machine-learned language model to allocate the transaction into one of the transaction rules;
receiving an output from the machine-learned language model; and
allocating the transaction data to the one of the transaction rules based on the output from the machine-learned language model.

2. The method of claim 1, wherein receiving transaction data of the transaction associated with the user account of the user comprises:
detecting a transaction associated with the user account of the user;
determining components of the transaction data, wherein the components of the transaction data comprise any one of: a transaction amount, a date and a time of the transaction, a merchant, a counter-party information, a location of the transaction, and the user account used for the transaction; and
formatting the transaction data for processing.

3. The method of claim 1, wherein generating the first embedding from the transaction data, the first embedding being in the latent space of the machine-learned model, comprises:
converting each component of the transaction data into numerical values to form a numerical representation;
applying the first machine-learned model trained on similar transaction data to the numerical representation to transform it into the first embedding; and
placing the first embedding in the latent space of the trained machine-learned model, where a position of the first embedding is determined by characteristics of the transaction data such that transactions with similar characteristics and categories are positioned closer to each other in the latent space.

4. The method of claim 1, wherein generating the second embeddings of the past transactions of the user comprises:
retrieving historical transaction data of the user, wherein the historical transaction data of the user comprises any one of characteristics of the past transactions and assigned categories of the past transactions; and
converting the historical transaction data of the user into numerical values to generate the second embeddings using a machine-learned model, wherein each one of the second embeddings represents a past transaction of the user in the latent space, where transactions with similar characteristics are encoded as similar embedding.

5. The method of claim 1, wherein comparing the second embeddings of the past transactions to the first embedding in the latent space comprises:
retrieving the first embedding and the second embeddings in the latent space; and
computing a distance between the first embedding and each of the second embeddings, wherein the distance between the first embedding and each of the second embeddings is a measure of closeness between embeddings in the latent space representing how similar the transaction is to each of the past transactions.

6. The method of claim 5, wherein identifying the set of past transactions that are similar to the transaction based on comparing the second embeddings to the first embedding comprises:
generating a list of past transactions based on the distance between the first embedding and each of the second embeddings, wherein a number of past transactions with their second embeddings closer to the first embedding are selected.

7. The method of claim 1, wherein compiling the prompt that includes the transaction and the set of past transactions of the user comprises:
extracting data from the transaction and the set of past transactions, wherein the data comprises any one of purchase details, merchant name, date and time, transaction amount, and, for past transactions, their assigned spending categories; and
generating the prompt based on the extracted data, wherein the prompt is a data structure that describes the transaction in the context of similar past transactions, wherein the data structure is formatted into a natural language for processing by a machine-learned language model.

8. The method of claim 1, wherein allocating the transaction data to the one of the transaction rules based on the output from the machine-learned language model comprises:
comparing the output from the machine-learned model to a dataset of spend allocations of the user;
determining if the output from the machine-learned model matches a spend allocation data within the dataset of the spend allocations of the user; and
if the output from the machine-learned model matches a spend allocation data within the dataset of the spend allocations of the user, allocating the transaction data to a spend allocation associated with the matched spend allocation data.

9. The method of claim 1, wherein allocating the transaction data to the spend allocation associated with the matched spend allocation data comprises:
identifying a confidence score of the output from the machine-learned model;
comparing the confidence score of the output from the machine-learned model to a predetermined threshold; and
if the confidence score of the output from the machine-learned model exceeds the predetermined threshold, allocating the transaction data to the spend allocation associated with the matched spend allocation data.

10. The method of claim 1, wherein allocating the transaction data to the one of the transaction rules based on the output from the machine-learned language model comprises:
comparing the output from the machine-learned model to a dataset of spend allocations of the user;
determining if the output from the machine-learned model matches one spend allocation data within the dataset of the spend allocations of the user;
if the output from the machine-learned model does not match one allocation data within the dataset of the spend allocations of the user, identifying a subset of the dataset of spend allocations of the user that is close or similar to the output from the machine-learned model, wherein identifying the subset of the dataset of spend allocations of the user that is close or similar to the output from the machine-learned model comprises:
generating, in a latent space of a machine-learned model, an embedding of the output from the machine-learned model and an embedding of each spend allocation data in the dataset of spend allocations of the user,
comparing the embedding of the output from the machine-learned model and the embedding of each spend allocation data in the dataset of spend allocations of the user in the latent space, and
identifying the subset of the dataset of spend allocations of the user that is close or similar to the output from the machine-learned model based on comparing the embedding of the output from the machine-learned model and the embedding of each spend allocation data in the dataset of spend allocations of the user in the latent space; and
allocating the transaction data to a spend allocation of the subset of the dataset of spend allocations of the user that is close or similar to the output from the machine-learned model.

11. The method of claim 1, wherein allocating the transaction data to the one of the transaction rules based on the output from the machine-learned language model comprises:
requesting the user of the account to annotate the transaction, wherein requesting the user to annotate the transactions comprises:
identifying the user associated with the transaction, and
transmitting a message containing the annotation request to the user through a communication channel comprising a short message service (SMS) message, email, or a software as a service (SaaS) platform;
receiving, from the user, the annotations for the transaction through the communication channel; and
allocating the transaction data to a spend allocation based on the annotations for the transaction received from the user.

12. A non-transitory computer-readable storage medium configured to store computer code comprising instructions, the instructions, when executed by one or more processors, cause the one or more processors to:
receive transaction data of a transaction associated with a user account of a user, the user being associated with one or more transaction rules, wherein the user has one or more user accounts and the transaction rules impose one or more restrictions on the user that are applied across the one or more user accounts;
generate a first embedding from the transaction data, the first embedding being in a latent space of a first machine-learned model;
identify a set of past transactions of the user, wherein identifying the set of past transactions of the user comprises:
generating second embeddings of past transactions of the user,
comparing the second embeddings of the past transactions to the first embedding in the latent space, and
identifying the set of past transactions that are similar to the transaction based on comparing the second embedding to the first embedding;
compile a prompt that includes the transaction and the set of past transactions of the user;
input the prompt to a machine-learned language model to request the machine-learned language model to allocate the transaction into one of the transaction rules;
receive an output from the machine-learned language model; and
allocate the transaction data to the one of the transaction rules based on the output from the machine-learned language model.

13. The non-transitory computer-readable storage medium of claim 12, wherein receiving transaction data of the transaction associated with the user account of the user comprises:
detecting a transaction associated with the user account of the user;
determining components of the transaction data, wherein the components of the transaction data comprise any one of: a transaction amount, a date and a time of the transaction, a merchant, a counter-party information, a location of the transaction, and the user account used for the transaction; and
formatting the transaction data for processing.

14. The non-transitory computer-readable storage medium of claim 12, wherein generating the first embedding from the transaction data, the first embedding being in the latent space of the machine-learned model, comprises:
converting each component of the transaction data into numerical values to form a numerical representation;
applying the first machine-learned model trained on similar transaction data to the numerical representation to transform it into the first embedding; and
placing the first embedding in the latent space of the trained machine-learned model, where a position of the first embedding is determined by characteristics of the transaction data such that transactions with similar characteristics and categories are positioned closer to each other in the latent space.

15. The non-transitory computer-readable storage medium of claim 12, wherein generating the second embeddings of the past transactions of the user comprises:
retrieving historical transaction data of the user, wherein the historical transaction data of the user comprises any one of characteristics of the past transactions and assigned categories of the past transactions; and
converting the historical transaction data of the user into numerical values to generate the second embeddings using a machine-learned model, wherein each one of the second embeddings represents a past transaction of the user in the latent space, where transactions with similar characteristics are encoded as similar embedding.

16. The non-transitory computer-readable storage medium of claim 12, wherein comparing the second embeddings of the past transactions to the first embedding in the latent space comprises:
retrieving the first embedding and the second embeddings in the latent space; and
computing a distance between the first embedding and each of the second embeddings, wherein the distance between the first embedding and each of the second embeddings is a measure of closeness between embeddings in the latent space representing how similar the transaction is to each of the past transactions.

17. The non-transitory computer-readable storage medium of claim 16, wherein identifying the set of past transactions that are similar to the transaction based on comparing the second embeddings to the first embedding comprises:
generating a list of past transactions based on the distance between the first embedding and each of the second embeddings, wherein a number of past transactions with their second embeddings closer to the first embedding are selected.

18. The non-transitory computer-readable storage medium of claim 12, wherein compiling the prompt that includes the transaction and the set of past transactions of the user comprises:
extracting data from the transaction and the set of past transactions, wherein the data comprises any one of purchase details, merchant name, date and time, transaction amount, and, for past transactions, their assigned spending categories; and
generating the prompt based on the extracted data, wherein the prompt is a data structure that describes the transaction in the context of similar past transactions, wherein the data structure is formatted into a natural language for processing by a machine-learned language model.

19. The non-transitory computer-readable storage medium of claim 12, wherein allocating the transaction data to the one of the transaction rules based on the output from the machine-learned language model comprises:
comparing the output from the machine-learned model to a dataset of spend allocations of the user;
determining if the output from the machine-learned model matches a spend allocation data within the dataset of the spend allocations of the user; and
if the output from the machine-learned model matches a spend allocation data within the dataset of the spend allocations of the user, allocating the transaction data to a spend allocation associated with the matched spend allocation data.

20. A system, comprising:
one or more processors; and
memory configured to store instructions, the instructions, when executed by the one or more processors, cause the one or more processors to:
receive transaction data of a transaction associated with a user account of a user, the user being associated with one or more transaction rules, wherein the user has one or more user accounts and the transaction rules impose one or more restrictions on the user that are applied across the one or more user accounts;
generate a first embedding from the transaction data, the first embedding being in a latent space of a first machine-learned model;
identify a set of past transactions of the user, wherein identifying the set of past transactions of the user comprises:
generating second embeddings of past transactions of the user,
comparing the second embeddings of the past transactions to the first embedding in the latent space, and
identifying the set of past transactions that are similar to the transaction based on comparing the second embedding to the first embedding;
compile a prompt that includes the transaction and the set of past transactions of the user;
input the prompt to a machine-learned language model to request the machine- learned language model to allocate the transaction into one of the transaction rules;
receive an output from the machine-learned language model; and
allocate the transaction data to the one of the transaction rules based on the output from the machine-learned language model.
